(19) United States
(12) Patent Application Publication
(10) Pub. No.: US 2022/0330358 A1
(43) Pub. Date: Oct. 13, 2022

(54) SIDELINK RRC PROCEDURE

(71) Applicant: Telefonaktiebolaget LM Ericsson (publ), Stockholm (SE)

(72) Inventors: Antonino Orsino, Kirkkonummi (FI); Congchi Zhang, Shanghai (CN); Zhang Zhang, Beijing (CN)

(21) Appl. No.: 17/634,275

(22) PCT Filed: Aug. 13, 2020
(86) PCT No.: PCT/EP2020/072801

§ 371 Date: Feb. 10, 2022

(30) Foreign Application Priority Data
Aug. 14, 2019 (CN) PCT/CN2019/100524

(51) Int. Cl. H04W 76/14; H04W 76/27

(52) U.S. Cl. CPC H04W 76/14; H04W 76/27

(57) ABSTRACT

Embodiments of a method implemented in a Sidelink (SL) User Equipment (UE) and corresponding embodiments of an SL UE are disclosed. In some embodiments, the method comprises detecting a trigger for sending a Radio Resource Control (RRC) message, wherein the RRC information comprises a request for an RRC procedure related to one or more SL-related configurations, a message comprising information that informs a network about one or more changes made by the SL UE related to one or more SL configurations, or a message that both requests the RRC procedure and comprises the information that informs the network about the one or more changes made by the SL UE related to the one or more SL configurations. The method also comprises sending the RRC information to a network node. Embodiments of a method implemented in a network node and corresponding embodiments of a network node are also disclosed.

### TECHNICAL FIELD

The present disclosure relates to sidelink (SL) communication in a cellular communications system.

### BACKGROUND

In Third Generation Partnership Project (3GPP), the Dual Connectivity (DC) solution has been specified, both for Long Term Evolution (LTE) and between LTE and Fifth Generation (5G) New Radio (NR). In DC, two nodes are involved, a Master Node (MN, or Master enhanced or evolved Node B (eNB) (MeNB)) and a Secondary Node (SN, or Secondary eNB (SeNB)). Multi-connectivity (MC) is the case when there are more than two nodes involved. Also, it has been proposed in 3GPP that DC is used in Ultra Reliable Low Latency Communications (URLLC) cases to enhance the robustness and to avoid connection interruptions.

There are different ways to deploy a 5 G NR network with or without interworking with LTE (also referred to as Evolved Universal Terrestrial Radio Access (E-UTRA)) and Evolved Packet Core (EPC). In principle, NR and LTE can be deployed without any interworking, denoted by NR Stand-Alone (SA) operation. That is, the NR base station (gNB) in NR can be connected to the 5G Core Network (CN) (5 GCN), and the eNB in LTE can be connected to the EPC with no interconnection between the two (referred to herein as Option 1 and Option 2). On the other hand, the first supported version of NR is the so-called EN-DC (E-UTRAN-NR DC), referred to herein as Option 3. In such a deployment, DC between NR and LTE is applied with LTE as the master and NR as the secondary node. The Radio Access Network (RAN) node (gNB) supporting NR may not have a control plane connection to the core network (EPC), but instead may rely on LTE as the MN (MeNB). This is also called “Non-standalone NR.” Notice that, in this case, the functionality of an NR cell is limited and would be used for connected mode User Equipments (UEs) as a booster and/or diversity leg, but an RRC_IDLE UE cannot camp on these NR cells.

With introduction of 5 GC, other options may be also valid. As mentioned above, Option 2 supports standalone NR deployment where the gNB is connected to the 5 GC. Similarly, LTE can also be connected to the 5 GCN, referred to herein as Option 5 (also known as enhanced LTE (eLTE), E-UTRA/5 GC, or LTE/5 GCN, with the node referred to as a Next Generation eNB (NG-eNB)). In these cases, both NR and LTE are seen as part of the Next Generation RAN (NG-RAN) (and thus both the NG-eNB and the gNB can be referred to as NG-RAN nodes). It is worth noting that other variants of DC between LTE and NR will be standardized as part of NG-RAN connected to 5 GC, denoted by Multi-Radio DC (MR-DC). Thus, under the MR-DC umbrella are:
EN-DC (referred to herein as Option 3): LTE is the MN and NR is the SN (EPC CN employed),
NR E-UTRA DC (NE-DC) (referred to herein as Option 4): NR is the MN and LTE is the SN (5 GCN employed),
NG-RAN E-UTRA NR DC (NGEN-DC) (referred to herein as Option 7): LTE is the MN and NR is the SN (5 GCN employed), and
NR-DC (variant of Option 2): DC where both the MN and the SN are NR (5 GCN employed).

As migration for these options may differ for different operators, it is possible to have deployments with multiple options in parallel in the same network. For example, there could be an eNB supporting Options 3, 5, and 7 in the same network as an NR base station supporting Options 2 and 4. In combination with DC solutions between LTE and NR, it is also possible to support Carrier Aggregation (CA) in each cell group (i.e., Master Cell Group (MCG) and Secondary Cell Group (SCG)) and DC between nodes on the same Radio Access Technology (RAT) (e.g., NR-NR DC). For the LTE cells, a consequence of these different deployments is the co-existence of LTE cells associated to eNBs connected to EPC, 5 GC, or both EPC/5 GC.

As noted earlier, DC is standardized for both LTE and EN-DC. LTE DC and EN-DC are designed differently when it comes to which nodes control what. Basically, there are two options: centralized solutions such as LTE DC, and decentralized solutions such as EN-DC.

In the Control Plane (CP) architecture for DC in LTE DC and EN-DC the main difference is that, in EN-DC, the SN has a separate Radio Resource Control (RRC) entity (NR RRC). This means that the SN can also control the UE, sometimes without the knowledge of the MN, but often with the need to coordinate with the MN. In LTE DC, the RRC decisions are always coming from the MN (MN to UE). Note, however, that the SN still decides the configuration of the SN since it is only the SN itself that has knowledge of the resources, capabilities, etc. of the SN.

For EN-DC, the major changes compared to LTE DC are as follows:
the introduction of a split bearer from the SN (known as an SCG split bearer),
the introduction of a split bearer for RRC, and
the introduction of a direct RRC from the SN (also referred to as an SCG Signaling Radio Bearer (SRB)).

The SN is sometimes referred to as a Secondary gNB (SgNB) (where gNB is an NR base station), and the MN as MeNB in case the LTE is the MN and NR is the SN. In the other case where NR is the MN and LTE is the SN, the corresponding terms are SeNB and Master gNB (MgNB).

Split RRC messages are mainly used for creating diversity, and the sender can decide to either choose one of the links for scheduling the RRC messages or can duplicate the message over both links. In the downlink, the path switching between the MCG or SCG legs, or duplication of both, is left to network implementation. On the other hand, for the uplink, the network configures the UE to use the MCG, SCG, or both legs. The terms “leg,” “path,” and “Radio Link Control (RLC) bearer” are used interchangeably throughout this document.

Inter-node RRC messages are RRC messages that are sent either across the X2-, Xn-, or the NG-interface, either to or from the gNB, i.e., a single ‘logical channel’ is used for all RRC messages transferred across network nodes. The information could originate from or be destined for another RAT. In this regard, Table 1 below provides an excerpt from 3GPP Technical Specification (TS) 38.331V15.6.0.

CG-Config
This message is used to transfer the SCG radio configuration as generated by the SgNB or
SeNB.
Direction: Secondary gNB or eNB to master gNB or eNB.
CG-Config message

| | |
|---|---|
| -- ASN1START | |
| -- TAG-CG-CONFIG-START | |
| CG-Config ::= | SEQUENCE { |
| criticalExtensions | CHOICE { |
| c1 | CHOICE{ |
| cg-Config | CG-Config-IEs, |

spare3 NULL, spare2 NULL, spare1 NULL

| | |
|---|---|
| }, | |
| criticalExtensionsFuture | SEQUENCE {} |
| } | |
| } | |
| CG-Config-IEs ::= | SEQUENCE { |
| scg-CellGroupConfig | OCTET STRING (CONTAINING RRCReconfiguration) OPTIONAL, |
| scg-RB-Config | OCTET STRING (CONTAINING RadioBearerConfig) OPTIONAL, |
| configRestrictModReq | ConfigRestrictModReqSCG OPTIONAL, |
| drx-InfoSCG | DRX-Info OPTIONAL, |
| candidateCellInfoListSN | OCTET STRING (CONTAINING MeasResultList2NR) OPTIONAL, |
| measConfigSN | MeasConfigSN OPTIONAL, |
| selectedBandCombination | BandCombinationInfoSN OPTIONAL, |
| fr-InfoListSCG | FR-InfoList OPTIONAL, |
| candidateServingFreqListNR | CandidateServingFreqListNR OPTIONAL, |
| nonCriticalExtension | CG-Config-v1540-IEs OPTIONAL |
| } | |
| CG-Config-v1540-IEs ::= | SEQUENCE { |
| pSCellFrequency | ARFCN-ValueNR OPTIONAL, |
| reportCGI-RequestNR | SEQUENCE { |
| requestedCellInfo | SEQUENCE { |
| ssbFrequency | ARFCN-ValueNR, |
| cellForWhichToReportCGI | PhysCellId |
| } | OPTIONAL |
| } | OPTIONAL, |
| ph-InfoSCG | PH-TypeListSCG OPTIONAL, |
| nonCriticalExtension | CG-Config-v1560-IEs OPTIONAL |
| } | |
| CG-Config-v1560-IEs ::= | SEQUENCE { |
| pSCellFrequencyEUTRA | ARFCN-ValueEUTRA OPTIONAL, |
| scg-CellGroupConfigEUTRA | OCTET STRING OPTIONAL, |
| candidateCellInfoListSN-EUTRA | OCTET STRING OPTIONAL, |
| candidateServingFreqListEUTRA | CandidateServingFreqListEUTRA OPTIONAL, |
| needForGaps | ENUMERATED {true} OPTIONAL, |
| drx-ConfigSCG | DRX-Config OPTIONAL, |
| reportCGI-RequestEUTRA | SEQUENCE { |
| requestedCellInfoEUTRA | SEQUENCE { |
| eutraFrequency | ARFCN-ValueEUTRA, |
| cellForWhichToReportCGI-EUTRA | EUTRA-PhysCellId |
| } | OPTIONAL |
| } | OPTIONAL, |
| nonCriticalExtension | SEQUENCE {} OPTIONAL |
| } | |
| PH-TypeListSCG ::= | SEQUENCE (SIZE (1..maxNrofServingCells)) OF PH-InfoSCG |
| PH-InfoSCG ::= | SEQUENCE { |
| servCellIndex | ServCellIndex, |
| ph-Uplink | PH-UplinkCarrierSCG, |
| ph-SupplementaryUplink | PH-UplinkCarrierSCG OPTIONAL, |
| ... | |
| } | |
| PH-UplinkCarrierSCG ::= | SEQUENCE { |
| ph-Type1or3 | ENUMERATED {type1, type3}, |
| ... | |
| } | |
| MeasConfigSN ::= | SEQUENCE { |
| measuredFrequenciesSN | SEQUENCE (SIZE (1..maxMeasFreqsSN)) |
| | OF NR-FreqInfo OPTIONAL, |
| ... | |
| } | |
| NR-FreqInfo ::= | SEQUENCE { |
| measuredFrequency | ARFCN-ValueNR OPTIONAL, |
| ... | |
| } | |
| ConfigRestrictModReqSCG ::= | SEQUENCE { |
| requestedBC-MRDC | BandCombinationInfoSN OPTIONAL, |
| requestedP-MaxFR1 | P-Max OPTIONAL, |
| ..., | |
| [[ | |
| requestedPDCCH-BlindDetectionSCG | INTEGER (1..15) OPTIONAL, |
| requestedP-MaxEUTRA | P-Max OPTIONAL |
| ]] | |
| } | |
| BandCombinationIndex ::= | INTEGER (1..maxBandComb) |
| BandCombinationInfoSN ::= | SEQUENCE { |
| bandCombinationIndex | BandCombinationIndex, |
| requestedFeatureSets | FeatureSetEntryIndex |
| } | |
| FR-InfoList ::= | SEQUENCE (SIZE (1..maxNrofServingCells-1)) OF FR-Info |
| FR-Info ::= | SEQUENCE { |
| servCellIndex | ServCellIndex, |
| fr-Type | ENUMERATED {fr1, fr2} |
| } | |
| CandidateServingFreqUstEUTRA ::= | SEQUENCE (SIZE (1.. maxFreqIDC-MRDC)) |
| | OF ARFCN-ValueEUTRA |
| CandidateServingFreqUstNR ::= | SEQUENCE (SIZE (1.. maxFreqIDC-MRDC)) |
| | OF ARFCN-ValueNR |

```
-- TAG-CG-CONFIG-STOP
-- ASN1STOP
CG-Config field descriptions
candidateCellInfoListSN
Contains information regarding cells that the source secondary node suggests the target secondary gNB to
consider configuring.
candidateCellInfoListSN-EUTRA
Includes the MeasResultList3EUTRA as specified in TS 36.331 [10]. Contains information regarding cells that the
source secondary node suggests the target secondary eNB to consider configuring. This field is only used in NE-DC.
candidateServingFreqListNR, candidateServingFreqListEUTRA
Indicates frequencies of candidate serving cells for In-Device Co-existence Indication (see TS 36.331 [10]).
configRestrictModReq
Used by SN to request changes to SCG configuration restrictions previously set by MN to ensure UE capabilities
are respected. E.g. can be used to request configuring an NR band combination whose use MN has previously
forbidden.
drx-ConfigSCG
This field contains the complete DRX configuration of the SCG. This field is only used in NR-DC.
drx-InfoSCG
This field contains the DRX long and short cycle configuration of the SCG. This field is used in (NG)EN-DC and
NE-DC.
fr-InfoListSCG
Contains information of FR information of serving cells that include PScell and Scells configured in SCG.
measuredFrequenciesSN
Used by SN to indicate a list of frequencies measured by the UE.
needForGaps
In NE-DC, indicates wheter the SN requests gNB to configure measurements gaps.
ph-InfoSCG
Power headroom information in SCG that is needed in the reception of PHR MAC CE of MCG
ph-SupplementaryUplink
Power headroom information for supplementary uplink. In the case of (NG)EN-DC and NR-DC, this field is only
present when two UL carriers are configued for a serving cell and one UL carrier reports type1 PH while the
other reports type 3 PH.
ph-Type1or3
Type of power headroom for a certain serving cell in SCG (PSCell and activated SCells). Value type1 refers to
type 1 power headroom, value type3 refers to type 3 power headroom. (See TS 38.321 [3]).
ph-Uplink
Power headroom information for uplink.
pSCellFrequency, pSCellFrequencyEUTRA
Indicates the frequency of PSCell in NR (i.e., pSCellFrequency) or E-UTRA (i.e., pSCellFrequencyEUTRA). In this
version of the specification, pSCellFrequency is not used in NE-DC whereas pSCellFrequencyEUTRA is only used
in NE-DC.
reportCGI-RequestNR, reportCGI-RequestEUTRA
Used by SN to indicate to MN about configuring repotCGI procedure. The request may optionally contain
information about the cell for which SN intends to configure reportCGI procedure. In this version of the
specification, the reportCGI-RequestNR is used in (NG)EN-DC and NR-DC whereas repotCGI-RequestEUTRA is
used only for NE-DC.
requestedPDCCH-BlindDetectionSCG
Requested value of the reference number of cells for PDCCH blind detection allowed to be configured for the
SCG.
requestedP-MaxEUTRA
Requested valume for the maximu power for the serving cells the UE can use in E-UTRA SCG. This field is only
used in NE-DC.
requestedP-MaxFR1
Requested value for the maximum power for the serving cells on frequency range 1 (FR1) in this secondary cell
group (see TS 38.104 [12]) the UE can use in NR SCG.
requestedBC-MRDC
Used to request configuring an NR band combination and corresponding feature sets which are forbidden to use
by MN.
scg-CellGroupConfig
Contains the RRCReconfiguration message:
      to be sent to the UE, used upon SCG establishment or modification, as generated (entirely) by the
      (target) SgNB. In this case, the SN sets the RRCReconfiguration message in accordance with section 6
      e.g. regarding the “Need” or “Cond” statements.
    or
      including the current SCG configuration of the UE, when provided in response to a query from MN, or in
      SN triggered SN change in order to enable delta signaling by the target SN. In this case, the SN sets the
      RRCReconfiguration message in accordance with section 11.2.3.
The field is absent if neither SCG (re)configuration nor SCG configuration query nor SN triggered SN change is
performed, e.g. at inter-node capability/configuration coordination which does not result in SCG
(re)configuration towards the UE. This field is not applicable in NE-DC.
scg-CellGroupConfigEUTRA
Includes the E-UTRA RRCConnectionReconfiguration message as specified in TS 36.331 [10]. In this version of
the specification, the E-UTRA RRC message can only include the field scg-Configuration. Used to (re-)configure
the SCG configuration upon SCG establishment or modification, as generated (entirely) by the (target) SeNB.
This field is absent when master gNB uses full configuration option. This field is only used in NE-DC.
scg-RB-Config
Contains the IE RadioBearerConfig:
      to be sent to the UE, used to (re-)configure the SCG RB configuration upon SCG establishment or
      modification, as generated (entirely) by the (target) SgNB or SeNB. In this case, the SN sets the
      RadioBearerConfig in accordance with section 6, e.g. regarding the “Need” or “Cond” statements.
    or
      including the current SCG RB configuration of the UE, when provided in response to a query from MN or
      in SN triggered SN change in order to enable delta signaling by the target SN. In this case, the SN sets
      the RRCReconfiguration message in accordance with section 11.2.3.
The field is absent if neither SCG (re)configuration nor SCG configuration query nor SN triggered SN change is
performed, e.g. at inter-node capability/configuration coordination which does not result in SCG RB
(re)configuration.
selectedBandCombination
Indicates the band combination selected by SN for (NG)EN-DC, NE-DC, and NR-DC.
BandCombinationInfoSNfield descriptions
bandCombinationIndex
The position of a band combination in the supportedBandCombinationList
requestedFeatureSets
The position in the FeatureSetCombination which identifies one FeatureSetUplink/Downlink for each band entry
in the associated band combination
- CG-ConfigInfo
This message is used by master eNB or gNB to request the SgNB or SeNB to perform certain
actions e.g. to establish, modify or release an SCG. The message may include additional
information e.g. to assist the SgNB or SeNB to set the SCG configuration. It can also be used
by a CU to request a DU to perform certain actions, e.g. to establish, modify or release an
MCG or SCG.
  Direction: Master eNB or gNB to secondary gNB or eNB, alternatively CU to DU.
CG-ConfigInfo message
```

| | |
|---|---|
| -- ASN1START | |
| -- TAG-CG-CONFIGINFO-START | |
| CG-ConfigInfo ::= | SEQUENCE { |
| criticalExtensions | CHOICE { |
| c1 | CHOICE{ |
| cg-ConfigInfo | CG-ConfigInfo-IEs, |

spare3 NULL, spare2 NULL, spare1 NULL

| | |
|---|---|
| }, | |
| criticalExtensionsFuture | SEQUENCE {} |
| } | |
| } | |
| CG-ConfigInfo-IEs ::= | SEQUENCE { |
| ue-CapabilityInfo | OCTET STRING (CONTAINING UE-CapabilityRAT- |
| | ContainerList) OPTIONAL,-- Cond SN-AddMod |
| candidateCellInfoListMN | MeasResultList2NR OPTIONAL, |
| candidateCellInfoListSN | OCTET STRING (CONTAINING MeasResultList2NR) OPTIONAL, |
| measResultCeIlListSFTD-NR | MeasResultCeIlListSFTD-NR OPTIONAL, |
| scgFailureInfo | SEQUENCE { |
| failureType | ENUMERATED { t310-Expiry, randomAccessProblem, |
| | rlc-MaxNumRetx synchReconfigFailure-SCG, |
| | scg-reconfigFailure, |
| | srb3-IntegrityFailure}, |
| measResultSCG | OCTET STRING (CONTAINING MeasResultSCG-Failure) |
| } | OPTIONAL, |
| configRestrictInfo | ConfigRestrictInfoSCG OPTIONAL, |
| drx-InfoMCG | DRX-Info OPTIONAL, |
| measConfigMN | MeasConfigMN OPTIONAL, |
| sourceConfigSCG | OCTET STRING (CONTAINING RRCReconfiguration) OPTIONAL, |
| scg-RB-Config | OCTET STRING (CONTAINING RadioBearerConfig) OPTIONAL, |
| mcg-RB-Config | OCTET STRING (CONTAINING RadioBearerConfig) OPTIONAL, |
| mrdc-AssistanceInfo | MRDC-AssistanceInfo OPTIONAL, |
| nonCriticalExtension | CG-ConfigInfo-v1540-IEs OPTIONAL |
| } | |
| CG-ConfigInfo-v1540-IEs ::= | SEQUENCE { |
| ph-InfoMCG | PH-TypeListMCG OPTIONAL, |
| measResultReportCGI | SEQUENCE { |
| ssbFrequency | ARFCN-ValueNR, |
| cellForWhichToReportCGI | PhysCellId, |
| cgi-Info | CGI-InfoNR |
| } | OPTIONAL, |
| nonCriticalExtension | CG-ConfigInfo-v1560-IEs OPTIONAL |
| } | |
| CG-ConfigInfo-v1560-IEs ::= | SEQUENCE { |
| candidateCellInfoListMN-EUTRA | OCTET STRING OPTIONAL, |
| candidateCellInfoListSN-EUTRA | OCTET STRING OPTIONAL, |
| sourceConfigSCG-EUTRA | OCTET STRING OPTIONAL, |
| scgFailureInfoEUTRA | SEQUENCE { |
| failureTypeEUTRA | ENUMERATED { t313-Expiry, randomAccessProblem, |
| | rlc-MaxNumRetx scg-ChangeFailure}, |
| measResultSCG-EUTRA | OCTET STRING |
| } | OPTIONAL, |
| drx-ConfigMCG | DRX-Config OPTIONAL, |
| measResultReportCGI-EUTRA | SEQUENCE { |
| eutraFrequency | ARFCN-ValueEUTRA, |
| cellForWhichToReportCGI-EUTRA | EUTRA-PhysCellId, |
| cgi-InfoEUTRA | CGI-InfoEUTRA |
| } | OPTIONAL, |
| measResultCeIlListSFTD-EUTRA | MeasResultCeIlListSFTD-EUTRA OPTIONAL, |
| fr-InfoListMCG | FR-InfoList OPTIONAL, |
| nonCriticalExtension | SEQUENCE {} OPTIONAL |
| } | |
| ConfigRestrictInfoSCG ::= | SEQUENCE { |
| allowedBC-ListMRDC | BandCombinationInfoList OPTIONAL, |
| powerCoordination-FR1 | SEQUENCE { |
| p-maxNR-FR1 | P-Max OPTIONAL, |
| p-maxEUTRA | P-Max OPTIONAL, |
| p-maxUE-FR1 | P-Max OPTIONAL |
| } | OPTIONAL, |
| servCellIndexRangeSCG | SEQUENCE { |
| lowBound | ServCellIndex, |
| upBound | ServCellIndex |
| } | OPTIONAL, -- Cond SN-AddMod |
| maxMeasFreqsSCG | INTEGER(1..maxMeasFreqsMN) OPTIONAL, |

-- TBD Late Drop: If maxMeasIdentitiesSCG is used needs to be decided after RAN4 replies to the LS on measurement

| | |
|---|---|
| requirements for MR-DC. | |
| maxMeasIdentitiesSCG-NR | INTEGER(1..maxMeasIdentitiesMN) OPTIONAL, |
| ..., | |
| [[ | |
| maxNumberROHC-ContextSessionsSN | INTEGER(0.. 16384) OPTIONAL, |
| pdcch-BlindDetectionSCG | INTEGER (1..15) OPTIONAL, |
| selectedBandEntriesMN | SEQUENCE (SIZE (1..maxSimultaneousBands)) |
| | OF BandEntryIndex OPTIONAL |
| ]] | |
| } | |
| BandEntryIndex ::= | INTEGER (0.. maxNrofServingCells) |
| PH-TypeListMCG ::= | SEQUENCE (SIZE (1..maxNrofServingCells)) OF PH-InfoMCG |
| PH-InfoMCG ::= | SEQUENCE { |
| servCellIndex | ServCellIndex, |
| ph-Uplink | PH-UplinkCarrierMCG, |
| ph-SupplementaryUplink | PH-UplinkCarrierMCG OPTIONAL, |
| ... | |
| } | |
| PH-UplinkCarrierMCG ::= | SEQUENCE{ |
| ph-Type1or3 | ENUMERATED {type1, type3}, |
| ... | |
| } | |
| BandCombinationInfoList ::= | SEQUENCE (SIZE (1..maxBandComb)) OF BandCombinationInfo |
| BandCombinationInfo ::= | SEQUENCE { |
| bandCombinationIndex | BandCombinationIndex, |
| allowedFeatureSetsList | SEQUENCE (SIZE (1..maxFeatureSetsPerBand)) |
| | OF FeatureSetEntryIndex |
| } | |
| FeatureSetEntryIndex ::= | INTEGER (1.. maxFeatureSetsPerBand) |
| DRX-Info ::= | SEQUENCE { |
| drx-LongCycleStartOffset | CHOICE { |
| ms10 | INTEGER(0..9), |
| ms20 | INTEGER(0..19), |
| ms32 | INTEGER(0..31), |
| ms40 | INTEGER(0..39), |
| ms60 | INTEGER(0..59), |
| ms64 | INTEGER(0..63), |
| ms70 | INTEGER(0..69), |
| ms80 | INTEGER(0..79), |
| ms128 | INTEGER(0..127), |
| ms160 | INTEGER(0..159), |
| ms256 | INTEGER(0..255), |
| ms320 | INTEGER(0..319), |
| ms512 | INTEGER(0..511), |
| ms640 | INTEGER(0..639), |
| ms1024 | INTEGER(0..1023), |
| ms1280 | INTEGER(0..1279), |
| ms2048 | INTEGER(0..2047), |
| ms2560 | INTEGER(0..2559), |
| ms5120 | INTEGER(0..5119), |
| ms10240 | INTEGER(0..10239) |
| }, | |
| shortDRX | SEQUENCE { |
| drx-ShortCycle | ENUMERATED { |
| | ms2, ms3, ms4, ms5, ms6, ms7, ms8, ms10, |
| | ms14, ms16, ms20, ms30, ms32, ms35, ms40, ms64, |
| | ms80, ms128, ms160, ms256, ms320, ms512, ms640, spare9, |
| | spare8, spare7, spare6, spare5, spare4, spare3, spare2, spare1 }, |
| drx-ShortCycleTimer | INTEGER (1..16) |
| } | OPTIONAL |
| } | |
| MeasConfigMN ::= | SEQUENCE { |
| measuredFrequenciesMN | SEQUENCE (SIZE (1..maxMeasFreqsMN)) |
| | OF NR-FreqInfo OPTIONAL, |
| measGapConfig | SetupRelease { GapConfig } OPTIONAL, |
| gapPurpose | ENUMERATED {perUE, perFR1} OPTIONAL, |
| ..., | |
| [[ | |
| measGapConfigFR2 | SetupRelease { GapConfig } OPTIONAL |
| ]] | |
| } | |
| MRDC-AssistanceInfo ::= | SEQUENCE { |
| affectedCarrierFreqCombInfoListMRDC | SEQUENCE (SIZE (1..maxNrofCombIDC)) |
| | OF AffectedCarrierFreqCombInfoMRDC, |
| ... | |
| } | |
| AffectedCarrierFreqCombInfoMRDC ::= | SEQUENCE { |
| victim SystemType | VictimSystemType, |
| interferenceDirectionMRDC | ENUMERATED {eutra-nr, nr, other, utra-nr-other, |
| | nr-other, spare3, spare2, spare1}, |
| affectedCarrierFreqCombMRDC | SEQUENCE { |
| affectedCarrierFreqCombEUTRA | AffectedCarrierFreqCombEUTRA OPTIONAL, |
| affectedCarrierFreqCombNR | AffectedCarrierFreqCombNR |
| } OPTIONAL | |
| } | |
| VictimSystemType ::= | SEQUENCE { |
| gps | ENUMERATED {true} OPTIONAL, |
| glonass | ENUMERATED {true} OPTIONAL, |
| bds | ENUMERATED {true} OPTIONAL, |
| galileo | ENUMERATED {true} OPTIONAL, |
| wlan | ENUMERATED {true} OPTIONAL, |
| bluetooth | ENUMERATED {true} OPTIONAL |
| } | |
| AffectedCarrierFreqCombEUTRA ::= | SEQUENCE (SIZE (1..maxNrofServingCellsEUTRA)) |
| | OF ARFCN-ValueEUTRA |
| AffectedCarrierFreqCombNR ::= | SEQUENCE (SIZE (1..maxNrofServingCells)) |
| | OF ARFCN-ValueNR |
| -- TAG-CG-CONFIGINFO-STOP | |
| -- ASN1STOP | |

CG-ConfigInfo field descriptions
allowedBC-ListMRDC
A list of indices referring to band combinations in MR-DC capabilities from which SN is allowed to select the SCG
band combination. Each entry refers to a band combination numbered according to
supportedBandCombinationList in the UE-MRDC-Capability (in case of (NG)EN-DC or NE-DC) or UE-NR-
Capability (in case of NR-DC) and the Feature Sets allowed for each band entry. All MR-DC band combinations
indicated by this field comprise the MCG band combination, which is a superset of the MCG band(s) selected by MN.
candidateCellInfoListMN, candidateCellInfoListSN
Contains information regarding cells that the master node or the source node suggests the target gNB to
consider configuring.
For (NG)EN-DC, including CSI-RS measurement results in candidateCellInfoListMN is not supported in this
version of the specification. For NR-DC, including SSB and/or CSI-RS measurement results in
candidateCellInfoListMN is supported.
candidateCellInfoListMN-EUTRA, candidateCellInfoListSN-EUTRA
Includes the MeasResultList3EUTRA as specified in TS 36.331 [10]. Contains information regarding cells that the
master node or the source node suggests the target secondary eNB to consider configuring. These fields are
only used in NE-DC.
configRestrictInfo
Includes fields for which SgNB is explictly indicated to observe a configuration restriction.
drx-ConfigMCG
This field contains the complete DRX configuration of the MCG. This field is only used in NR-DC.
drx-InfoMCG
This field contains the DRX long and short cycle configuration of the MCG. This field is used in (NG)EN-DC and
NE-DC.
fr-InfoListMCG
Contains information of FR information of serving cells that include PCell and SCell(s) configured in MCG.
maxMeasFreqsSCG
Indicates the maximum number of NR inter-frequency carriers the SN is allowed to configure with PSCell for
measurements.
maxMeasIdentitiesSCG-NR
Indicates the maximum number of allowed measurement identities that the SCG is allowed to configure.
maxNumberROHC-ContextSessionsSN
Indicates the maximum number of context sessions allowed to SN terminated bearer, excluding context
sessions that leave all headers uncompressed.
measuredFrequenciesMN
Used by MN to indicate a list of frequencies measured by the UE.
measGapConfig
Indicates the FR1 and perUE measurement gap configuration configured by MN.
measGapConfigFR2
Indicates the FR2 measurement gap configuration configured by MN.
measResultCellListSFTD
Indicates the SFTD measurements between the PCell and the NR PSCell.
measResultReportCGI, measResultReportCGI-EUTRA
Used by MN to provide SN with CGI-Info for the cell as per SNPSCell. by MN.earer, excluding context sessions
that lmeasResultReportCGI is used for (NG)EN-DC and NR-DC and the measResultReportCGI-EUTRA is used
only for NE-DC.
measResultSCG-EUTRA
This field includes the MeasResultSCG-FailureMRDC IE as specified in TS 36.331 [10]. This field is only used in
NE-DC.
measResultSFTD-EUTRA
SFTD measurement results between the PCell and the E-UTRA PScell in NE-DC. This field is only used in NE-DC.
mcg-RB-Config
Contains all of the fields in the IE RadioBearerConfig used in MCG, used by the SN to support delta
configuration to UE, for bearer type change between MN terminated bearer with NR PDCP to SN terminated
bearer. It is also used to indicate the PDCP duplication related information for MN terminated split bearer
(whether duplication is configured and if so, whether it is initially activated) in SN Addition/Modification
procedure. Otherwise, this field is absent.
mrdc-AssistanceInfo
Contains the IDC assistance information for MR-DC reported by the UE (see TS 36.331 [10]).
pdcch-BlindDetectionSCG
Indicates the maximum value of the reference number of cells for PDCCH blind detection allowed to be
configured for the SCG.
p-maxEUTRA
Indicates the maximum total transmit power to be used by the UE in the E-UTRA cell group (see TS 36.104
[33]). This field is used in (NG)EN-DC and NE-DC.
p-maxNR-FR1
Indicates the maximum total transmit power to be used by the UE in the NR cell group across all serving cells in
frequency range 1 (FR1) (see TS 38.104 [12]) the UE can use in NR SCG.
p-maxUE-FR1
Indicates the maximum total transmit power to be used by the UE across all serving cells in frequency range 1
(FR1).
ph-InfoMCG
Power headroom information in MCG that is needed in the reception of PHR MAC CE in SCG.
ph-SupplementaryUplink
Power headroom information for supplementary uplink. For UE in (NG)EN-DC, this field is absent.
ph-Type1or3
Type of power headroom for a serving cell in MCG (PCell and activated SCells). type1 refers to type 1 power
headroom, type3 refers to type 3 power headroom. (See TS 38.321 [3]).
ph-Uplink
Power headroom information for uplink.
powerCoordination-FR1
Indicates the maximum power that the UE can use in FR1.
scgFailureInfo
Contains SCG failure type and measurement results. In case the sender has no measurement results available,
the sender may include one empty entry (i.e. without any optional fields present) in measResultsPerMOList.
This field is used in (NG)EN-DC and NR-DC.
scgFailureInfoEUTRA
Contains SCG failure type and measurement results of the EUTRA secondary cell group. This field is only used in
NE-DC.
scg-RB-Config
Contains all of the fields in the IE RadioBearerConfig used in SCG, used to allow the target SN to use delta
configuration to the UE, e.g. during SN change. The field is signalled upon change of SN. Otherwise, the field is
absent. This field is also absent when master eNB uses full configuration option.
selectedBandEntiesMN
Indicates the position of a band entry selected by the MN, in the first band combination entry in allowedBC-
ListMRDC IE. Each band entry in the subset is identified by its position in the bandlist of this BandCombinaiton.
The SN uses this information to determine which bands out of the NR band combinations in allowedBC-
ListMRDC it can configure in SCG. This field is only used in NR-DC.
servCellIndexRangeSCG
Range of serving cell indices that SN is allowed to configure for SCG serving cells.
sourceConfigSCG
Includes all of the current SCG configurations used by the target SN to build delta configuration to be sent to
UE, e.g. during SN change. The field contains the RRCReconfiguration message, i.e. including CellGroupConfig
and measConfig. The field is signalled upon change of SN, unless MN uses full configuration option. Otherwise,
the field is absent.
sourceConfigSCG-EUTRA
Includes the E-UTRA RRCConnectionReconfiguration message as specified in TS 36.331 [10]. In this version of
the specification, the E-UTRA RRC message can only include the field scg-Configuration. In this version of the
specification, this field is absent when master gNB uses full configuration option. This field is only used in NE-DC.
ue-CapabilityInfo
Contains the IE UE-CapabilityRAT-ContainerList supported by the UE (see NOTE 3). The field is signalled upon
addition, modification or change of SN.
BandCombinationInfo field descriptions
allowedFeatureSetsList
Defines a subset of the entries in a FeatureSetCombination. Each index identifies a position in the
FeatureSetCombination, which corresponds to one FeatureSetUplink1 Downlink for each band entry in the
associated band combination.
bandCombinationIndex
The position of a band combination in the supportedBandCombinationList

| Conditional | |
|---|---|
| Presence | Explanation |
| SN-AddMod | The field is mandatory present upon SN addition and SN change. |
| | It is optionally present upon SN modification. Otherwise, the field is absent. |

NOTE 3: The following table indicates per source RAT whether RAT capabilities are included or not in ue-CapabilityInfo.

| | | | |
|---|---|---|---|
| Source RAT | NR capabilities | E-UTRA capabilities | MR-DC capabilities |
| E-UTRA | Included | Not included | Included |

Cellular Intelligent Transport Systems (ITS) (C-ITS) aim to define a new cellular ecosystem for the delivery of vehicular services and their dissemination. Such an ecosystem includes both short range and long range V2X service transmissions. In particular, short range communication involves transmissions over a Device-to-Device (D2D) link (also defined as a Sidelink (SL) or PC5 interface in 3GPP), towards other vehicular UEs or Road Side Units (RSUs). On the other hand, for long range transmission, it considers the transmission over the Uu interface between a UE and a base station, in which case packets may be disseminated to different ITS service providers, which could be road traffic authorities, road operators, automotive Original Equipment Manufacturers (OEMs), cellular operators, etc.

When it comes to the SL interface, the first standardization effort in 3GPP dates back to Release (Rel) 12, targeting public safety use cases. Since then, a number of enhancements have been introduced with the objective of enlarging the use cases that could benefit from the D2D technology. Particularly, in LTE Rel-14 and Rel-15, the extensions for the D2D work consists of supporting V2X communication, including any combination of direct communication between vehicles (Vehicle-to-Vehicle (V2V)), pedestrians (Vehicle-to-Pedestrian (V2 P)), and infrastructure (Vehicle-to-Infrastructure (V2 I)).

In RAN #80, a new Study Item named “Study on NR V2X” was approved to study the enhancement to support advanced V2X services beyond services supported in LTE Rel-15V2X. One of the objectives for NR V2X design is to study technical solutions for Quality of Service (QoS) management of the radio interface including both Uu (i.e., network-to-vehicle UE communication) and SL (i.e., vehicle UE-to-vehicle UE communication) used for V2X operations.

While LTE V2X mainly aims at traffic safety services, NR V2X has a much broader scope that not only includes basic safety services, but also targets non-safety applications such as extended sensor/data sharing between vehicles, with the objective of strengthening the perception of the surrounding environment of vehicles. Hence, a new set of applications have been captured in 3GPP Technical Report (TR) 22.886 V16.2.0 that would require an enhanced NR system and new NR SL framework. These applications include advanced driving, vehicle platooning, cooperative maneuvers between vehicles, and remote driving.

In this new context, the expected requirements to meet the needed data rate, capacity, reliability, latency, communication range, and speed are made more stringent. Additionally, both PC5 and Uu communication interfaces could be used to support the advanced V2X use cases, taking into account radio conditions and the environment where the enhanced V2X (eV2X) scenario takes place. For example, given the variety of services that can be transmitted over the SL, a robust QoS framework which takes into account the different performance requirements of the different V2X services seems to be needed. Additionally, NR protocols to handle more robust and reliable communication should be designed. All of these issues are currently under the investigation of 3GPP in NR Rel-16.

In NR, a SL QoS flow model is adopted. At the Non-Access Stratum (NAS) layer, the UE maps one V2X packet into the corresponding SL QoS flow and then maps to an SL radio bearer at the Service Data Adaptation Protocol (SDAP) layer.

In NR, SL Radio Bearer (SLRB) configuration, including the SL QoS flow to SLRB mapping, is either preconfigured or configured by the network when the UE is in coverage. For instance, when the UE wants to establish a new SL QoS flow/SLRB for a new service, the UE can send a request to the associated gNB. The request can include the QoS information of the service. The gNB then determines the appropriate SLRB configuration to support such an SL QoS flow. After receiving the SLRB configuration from the gNB, the UE establishes the local SLRB accordingly and prepares for data transmission over the SL. Note that to enable successful reception at the reception (RX) UE, the transmission (TX) UE might have to inform the RX UE regarding necessary parameters (e.g., sequence number space for Packet Data Convergence Protocol (PDCP)/RLC) before the data transmission starts.

RRC operation depends on the UE specific states. A UE is in either in RRC_CONNECTED state, RRC_INACTIVE state, or RRC_IDLE state. The different RRC states have different amounts of radio resources associated with them that the UE may use in that specific state. In RRC_INACTIVE and RRC_IDLE state, UE controlled mobility based on network configuration is adopted (i.e., the UE acquires System Information Block (SIB), performs neighboring cell measurements and cell selection and re-selection, and monitors a paging occasion). An inactive UE stores the UE inactive Access Stratum (AS) context and performs RAN-based Notification Area (RNA) updates.

In RRC_CONNECTED state, however, network-controlled mobility is performed. In fact, the RAN node can receive paging assistance information related to potential paging triggers, such as QoS flows or signaling, from the 5 GCN. The UE is thus known by the network at the node/cell level, and a UE specific bearer is established upon which UE specific data and/or control signaling could be communicated. For example, the RAN can configure UE-specific RNAs that make it possible to reduce the total signaling load by configuring small RNAs for stationary UEs (optimized for low paging load) and, especially, larger RNAs for moving UEs (optimized for vehicular UEs).

Furthermore, if, e.g., there is no traffic transmission and/or reception for a certain time period, the network can initiate the RRC connection release procedure to transmit a UE in RRC_CONNECTED to RRC_IDLE; or to RRC_INACTIVE if SRB2 and at least one Data Radio Bearer (DRB) is set up in RRC_CONNECTED.

There are two different Resource Allocation (RA) procedures for V2X on SL, i.e., network-controlled RA (so called “mode 3” in LTE and “mode 1” in NR) and autonomous RA (so called “mode 4” in LTE and “mode 2” in NR). The transmission resources are selected within a resource pool which is, e.g., predefined or configured by the network.

With network-controlled RA, NG-RAN is in charge of scheduling SL resource(s) to be used by the UE for SL transmission(s). The UE sends an SL Buffer Status Report (BSR) to the network to inform the network about SL data available for transmission in the SL buffers associated with the Medium Access Control (MAC) entity. The network then signals the resource allocation to the UE using Downlink Control Information (DCI). Network-controlled (or mode 1) RA may be realized via dynamic scheduling signalling via the Physical Downlink Control Channel (PDCCH), or by semi-persistent scheduling in which the gNB provides one or more configured SL grants. Both type-1 and type-2 configured SL grants are supported.

With autonomous RA, each device independently decides which SL radio resources to use for SL operations based on, e.g., sensing. For both RA modes, SL Control Information (SCI) is transmitted on the Physical Sidelink Control Channel (PSCCH) to indicate the assigned SL resources for the PSSCH. Unlike network-controlled RA, which can only be performed when the UE is in RRC_CONNECTED state, autonomous RA (or mode 2) can be performed both when the UE is in RRC_CONNECTED state and when the UE is in INACTIVE/IDLE state, and also when the UE is under Uu coverage and out-of-coverage. In particular, when the UE is in RRC_CONNECTED state, the SL resource pool can be configured with dedicated RRC signalling, while for IDLE/INACTIVE mode operations, the UE shall rely on the SL resource pool provisioned in the broadcasting signal, i.e., SIB.

Currently, as part of the NR-V2X study item, 3GPP is investigating possible extension of such mode 2. For example, 3GPP is considering the possibility of introducing a new UE functionality in which a UE, under certain conditions (e.g., for groupcast SL communication), is allowed to provision other UEs with a mode 2 pool to be used for SL communication (e.g., for SL communication within a group of UEs, such as a platoon of vehicles).

Configured grant is supported for NR SL, for both type 1 and type 2. With configured grant, the gNB can allocate SL resources for multiple (periodical) transmissions to the UE. Type 1 configured grant is configured and activated directly via dedicated RRC signaling. Type 2 configured grant is configured via dedicated RRC signaling, but only activated/released via DCI transmitted on PDCCH.

### SUMMARY

Systems and methods are disclosed herein for enabling a Sidelink (SL) User Equipment (UE) to send a Radio Resource Control (RRC) message to the network in order to request an RRC procedure (e.g., in association with an SL). Embodiments of a method implemented in an SL UE are disclosed herein. In some embodiments, the method comprises detecting a trigger for sending an RRC information or message, wherein the RRC message comprises a request for an RRC procedure related to one or more SL-related configurations, a message comprising information that informs a network about one or more changes made by the SL UE related to one or more SL configurations, or a message that both requests the RRC procedure related to the one or more SL-related configurations and comprises the information that informs the network about the one or more changes made by the SL UE related to the one or more SL configurations. The method further comprises sending the RRC message to a network node.

In some embodiments, the RRC information or message comprises either the request for the RRC procedure related to the one or more SL-related configurations, or the message that both requests the RRC procedure related to the one or more SL-related configurations and comprises the information that informs the network about the one or more changes made by the SL UE related to the one or more SL configurations. In such embodiments, the RRC procedure comprises either an SL configuration procedure or an SL configuration update procedure. In some embodiments, detecting the trigger for sending the RRC message comprises detecting one or more criteria, the one or more criteria comprising a criterion that an SL Radio Bearer (SLRB) reconfiguration is needed, a criterion that there is a new SL Quality of Service (QoS) flow but no QoS mapping for the new SL QoS flow, a criterion that a new SL QoS mapping is needed, a criterion of a change in an SL-related UE context at the SL UE, or a criterion of performance of one or more autonomous SL-related actions by the SL UE. In some embodiments, the criterion of performance of the one or more autonomous SL-related actions by the SL UE comprises a criterion of autonomously deciding a new SL-related QoS mapping rule or a criterion of autonomously updating an SL-related UE context.

In some embodiments, sending the RRC information or message to the network node comprises sending the RRC message to the network node upon detecting the trigger. According to some embodiments, detecting the trigger for sending the RRC message comprises detecting the trigger for sending the RRC message while the SL UE is in an idle or inactive state, and sending the RRC message to the network node comprises sending the RRC message to the network node upon detecting the trigger and transitioning from the idle or inactive state to a connected state. In some embodiments, sending the RRC message to the network node comprises sending the RRC message to the network node when in a connected state, and the RRC message comprises an existing SL-related RRC message. Some such embodiments provide that the existing SL-related RRC message comprises a SidelinkUElnformation message.

In some embodiments, sending the RRC message to the network node comprises sending the RRC message to the network node when in a connected state, and the RRC message comprises an existing NR or Long Term Evolution (LTE) RRC message. Some such embodiments provide that the existing NR or LTE RRC message comprises a UEAssistancelnformation message, a ULlnformationTransfer message, or a ULlnformationTransferMRDC message. In some embodiments, sending the RRC message to the network node comprises sending the RRC message to the network node when in a connected state, and the RRC message comprises a new RRC message that is common for two or more Radio Access Technologies (RATs). According to some embodiments, sending the RRC message to the network node comprises sending the RRC message to the network node when in a connected state, and the RRC message comprises a new RRC message that is for SL only.

In some embodiments, sending the RRC information or message to the network node comprises sending the RRC message to the network node when in an idle or inactive state, and the RRC message comprises an existing RRC message. Some such embodiments provide that the existing RRC message comprises an RRCResumeRequest message or an RRCSetupRequest message. In some embodiments, sending the RRC message to the network node comprises sending the RRC message to the network node when in an idle or inactive state, and the RRC message comprises a new RRC message that is common for two or more RATs.

According to some embodiments, sending the RRC message to the network node comprises sending the RRC message to the network node when in an idle or inactive state, and the RRC message comprises a new RRC message that is used for SL only.

In some embodiments, the RRC message comprises a flag that indicates a request for a new SLRB configuration. Some embodiments provide that the RRC message comprises QoS flow information for one or more QoS flows at the SL UE. According to some embodiments, the RRC message further comprises an indication of one or more new QoS mappings needed for the one or more QoS flows. In some embodiments, the RRC message comprises a new SL-related UE context for the SL UE.

According to some embodiments, the method further comprises receiving a response from either the network node or another network node. In some embodiments, the response comprises one or more SL-related configurations or one or more updates to one or more SL-related configurations. Some embodiments provide that the method further comprises taking one or more actions based on the response. In some embodiments, the network node comprises a base station. According to some embodiments, the SL UE uses Dual Connectivity (DC), and the network node comprises a Master Node (MN) of the SL UE. Some embodiments provide that the SL UE uses DC, and the network node comprises a Secondary Node (SN) of the SL UE.

Embodiments of an SL UE are also disclosed herein. In some embodiments, the SL UE is adapted to detect a trigger for sending an RRC message, wherein the RRC message comprises a request for an RRC procedure related to one or more SL-related configurations, a message comprising information that informs a network about one or more changes made by the SL UE related to one or more SL configurations, or a message that both requests the RRC procedure related to the one or more SL-related configurations and comprises the information that informs the network about the one or more changes made by the SL UE related to the one or more SL configurations. The SL UE is further adapted to send the RRC message to a network node. According to some embodiments, the SL UE is further adapted to perform any of the steps attributed to the SL UE in the above-disclosed methods.

Embodiments of an SL UE are further disclosed herein. In some embodiments, the SL UE comprises one or more transmitters, one or more receivers, and processing circuitry associated with the one or more transmitters and the one or more receivers. The processing circuitry is configured to cause the SL UE to detect a trigger for sending an RRC, message, wherein the RRC message comprises a request for an RRC procedure related to one or more SL-related configurations, a message comprising information that informs a network about one or more changes made by the SL UE related to one or more SL configurations, or a message that both requests the RRC procedure related to the one or more SL-related configurations and comprises the information that informs the network about the one or more changes made by the SL UE related to the one or more SL configurations. The processing circuitry is further configured to cause the SL UE to send the RRC message to a network node. According to some embodiments, the processing circuitry is further configured to cause the SL UE to perform any of the steps attributed to the SL UE in the above-disclosed methods.

Embodiments of a method implemented in a network node are also disclosed herein. In some embodiments, the method comprises receiving an RRC message from an SL UE, wherein the RRC message is a request for an RRC procedure related to one or more SL-related configurations, a message comprising information about one or more changes made by the SL UE related to one or more SL configurations, or a message that both requests the RRC procedure related to the one or more SL-related configurations and comprises the information about the one or more changes made by the SL UE related to the one or more SL configurations. The method further comprises taking one or more actions based on the RRC message. According to some embodiments, the one or more actions comprise sending the RRC message or information in the RRC message to another network node. In some embodiments, the one or more actions comprise sending a response to the SL UE, and the response comprises the one or more SL-related configurations for the SL UE or one or more updates to the one or more SL-related configurations for the SL UE.

In some embodiments, the RRC message comprises either the request for the RRC procedure related to the one or more SL-related configurations, or the message that both requests the RRC procedure related to the one or more SL-related configurations and comprises the information about the one or more changes made by the SL UE related to the one or more SL configurations. In such embodiments, the RRC procedure comprises either an SL configuration procedure or an SL configuration update procedure. In some embodiments, receiving the RRC message from the SL UE comprises receiving the RRC message from the SL UE while the SL UE is in a connected state, and the RRC message comprises an existing SL-related RRC message. According to some such embodiments, the existing SL-related RRC message comprises a SidelinkUElnformation message.

In some embodiments, receiving the RRC message from the SL UE comprises receiving the RRC message from the SL UE while the SL UE is in a connected state, and the RRC message comprises an existing NR or LTE RRC message. Some such embodiments provide that the existing NR or LTE RRC message comprises a UEAssistancelnformation message, a ULlnformationTransfer message, or a ULlnformationTransferMRDC message. In some embodiments, receiving the RRC message from the SL UE comprises receiving the RRC message from the SL UE while the SL UE is in a connected state, and the RRC message comprises a new RRC message that is common for two or more RATs. Some embodiments provide that receiving the RRC message from the SL UE comprises receiving the RRC message from the SL UE while the SL UE is in a connected state, and the RRC message comprises a new RRC message that is for SL only. According to some embodiments, receiving the RRC message from the SL UE comprises receiving the RRC message from the SL UE while the SL UE is in an idle or inactive state, and the RRC message comprises an existing RRC message. In some such embodiments, the existing RRC message comprises an RRCResumeRequest message or an RRCSetupRequest message.

In some embodiments, receiving the RRC message from the SL UE comprises receiving the RRC message from the SL UE while the SL UE is in an idle or inactive state, and the RRC message comprises a new RRC message that is common for two or more RATs. According to some embodiments, receiving the RRC message from the SL UE comprises receiving the RRC message from the SL UE while the SL UE is in an idle or inactive state, and the RRC message comprises a new RRC message that is used for SL only. Some embodiments provide that the RRC message comprises a flag that indicates a request for a new SLRB configuration. In some embodiments, the RRC message comprises QoS flow information for one or more QoS flows at the SL UE. Some such embodiments provide that the RRC message further comprises an indication of one or more new QoS mappings needed for the one or more QoS flows.

In some embodiments, the RRC message comprises a new SL-related UE context for the SL UE. Some embodiments provide that the network node comprises a base station. According to some embodiments, the SL UE uses DC, and the base station comprises an MN of the SL UE. In some embodiments, the SL UE uses DC, and the base station comprises an SN of the SL UE.

Embodiments of a base station are further disclosed herein. In some embodiments, the base station is adapted to receive an RRC message from an SL UE, wherein the RRC message is a request for an RRC procedure related to one or more SL-related configurations, a message comprising information about one or more changes made by the SL UE related to one or more SL configurations, or a message that both requests the RRC procedure related to the one or more SL-related configurations and comprises the information about the one or more changes made by the SL UE related to the one or more SL configurations. The base station is further adapted to take one or more actions based on the RRC message. In some embodiments, the base station is also adapted to perform any of the steps attributed to the base station in the above-disclosed methods.

Embodiments of a base station are also disclosed herein. In some embodiments, the base station comprises processing circuitry configured to cause the base station to receive an RRC message from a SL UE, wherein the RRC message is a request for an RRC procedure related to one or more SL-related configurations, a message comprising information about one or more changes made by the SL UE related to one or more SL configurations, or a message that both requests the RRC procedure related to the one or more SL-related configurations and comprises the information about the one or more changes made by the SL UE related to the one or more SL configurations. The processing circuitry is further configured to cause the base station to take one or more actions based on the RRC message. In some embodiments, the processing circuitry is also configured to cause the base station to perform any of the steps attributed to the base station in the above-disclosed methods.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications system in which embodiments of the present disclosure may be implemented;

FIG. 2 illustrates the operation of a base station and an SL User Equipment (UE) in accordance with some embodiments of the present disclosure;

FIG. 3 is a schematic block diagram of a radio access node according to some embodiments of the present disclosure;

FIG. 4 is a schematic block diagram that illustrates a virtualized embodiment of the radio access node of FIG. 3 according to some embodiments of the present disclosure; and

FIG. 5 is a schematic block diagram of a UE according to some embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless device.

Radio Access Node: As used herein, a “radio access node” or “radio network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5 G) NR network or an enhanced or evolved Node B (eNB) in a 3GPP Long Term Evolution (LTE) network), a high-power or macro base station, a low-power base station (e.g., a micro base station, a pico base station, a home eNB, or the like), and a relay node.

Core Network Node: As used herein, a “core network node” is any type of node in a Core Network (CN) or any node that implements a CN function. Some examples of a CN node include, e.g., a Mobility Management Entity (MME), a Packet Data Network Gateway (P-GW), a Service Capability Exposure Function (SCEF), a Home Subscriber Server (HSS), or the like. Some other examples of a CN node include a node implementing a Access and Mobility Function (AMF), a User Plane (UP) Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Wireless Device: As used herein, a “wireless device” is any type of device that has access to (i.e., is served by) a cellular communications network by wirelessly transmitting and/or receiving signals to a radio access node(s). Some examples of a wireless device include, but are not limited to, a User Equipment device (UE) in a 3GPP network and a Machine Type Communication (MTC) device.

Sidelink Wireless Device: As used herein, a “sidelink wireless device,” “sidelink capable wireless device,” “sidelink UE,” or “sidelink capable UE” is a wireless device or UE capable of Sidelink (SL) communication.

Network Node: As used herein, a “network node” is any node that is either part of the RAN or the CN of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5 G NR concepts, beams may be used instead of cells and, as such, it is important to note that the concepts described herein are equally applicable to both cells and beams.

In NR, SL Radio Bearer (SLRB) configuration, including the SL Quality of Service (QoS) flow to SLRB mapping, is either preconfigured or configured by the network when the UE is in coverage. For this latter case, at the moment, there is no signaling support on how the UE may request an SLRB reconfiguration or new SLRB configuration to support a new SL QoS flow. This lack of signaling not only impacts the SLRB configuration to the QoS flow mapping, but it may also impact other Radio Resource Control (RRC) procedures, e.g., updating the UE SL context at the network side. In particular, if the UE is not able to request a certain RRC procedure to the network, this will lead to SL (re)configuration errors, connectivity interruptions, and signaling overhead.

Systems and methods are disclosed herein for enabling an SL UE to send an RRC message to the network in order to request an RRC procedure (e.g., in association with an SL) from the network (or to just send an indication to the network), e.g., when certain circumstances happen (e.g., when new QoS flows pop up in the SL UE, SL UE context becomes un-synchronized with that one stored at the gNB/eNB, or a new SLRB configuration is required). The requested RRC procedure may be (but is not limited to) a new SL configuration or an SL configuration update. The same RRC procedure can also be used to send an indication to the network by the SL UE. In this way, (re)configuration errors, connectivity interruption, and signaling overhead among the SL UEs and the network can be prevented.

In some embodiments, an SL UE may request an RRC procedure (or send just an indication) to the network when certain circumstances happen (e.g., new QoS flows pop up in the SL UE, SL UE context becomes un-synchronized with the one stored at the NR Base Station (gNB)/enhanced or evolved Node B (eNB), or a new SLRB configuration is required). Some example benefits of embodiments of the present disclosure may include:
SL service continuity may be guaranteed and a new QoS flow may be correctly mapped to the SLRB without any errors.
Signaling overhead between the SL UE and the network may be reduced since the network is aware in case the SL UE needs a new configuration, a new QoS mapping, or to synchronize the SL UE context.
(Re)configuration errors may be avoided. The SL UE may be capable of requesting updated configuration to the network.

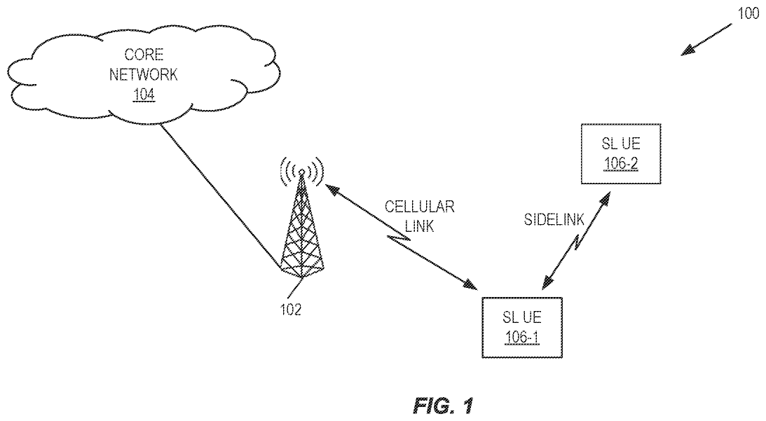

In this regard, FIG. 1 illustrates one example of a cellular communications system 100 in which embodiments of the present disclosure may be implemented. In the embodiments described herein, the cellular communications system 100 is a 5 G System (5 GS) including an NR RAN. However, the present disclosure is not limited thereto. Rather, embodiments of the present disclosure may be implemented in other types of wireless communications systems that enable SL communications. In this example, the RAN includes a base station 102, which in 5 G NR is referred to as a gNB or Next Generation RAN (NG-RAN) node, controlling a corresponding cell. The cellular communications system 100 also includes a core network 104, which in the 5 GS is referred to as the 5 G CN (5 GCN). The core network 104 may alternatively be the Evolved Packet Core (EPC). The base station 102 is connected to the core network 104.

The cellular communications system 100 also includes SL wireless devices 106-1 and 106-2, which are also referred to herein as SL UEs 106-1 and 106-2. In this example, the SL UE 106-1 has a cellular link to the base station 102 and an SL to the other SL UE 106-2.

Now, a description of some example embodiments will be provided. Note that the following embodiments are described for NR, but they may be applied to LTE or any other Radio Access Technology (RAT). Further, the NG-RAN nodes may be connected to the 5 GC or to the EPC. In case of Dual Connectivity (DC), the disclosed solution can be applied to all the Multi-Radio DC (MR-DC) options as described in, e.g., 3GPP Technical Specification (TS) 37.340V15.6.0.

Embodiments are disclosed herein for enabling an SL UE (e.g., the SL UE 106-1) to send an RRC message to the network (e.g., to the base station 102) in order to request an RRC procedure or inform the network about some change(s) or situation(s) in, e.g., SL communications. The requested RRC procedure may be (but is not limited to) a new SL configuration or a configuration update. The same RRC procedure can also be used to send an indication to the network by the SL UE. Alternatively, the SL UE may decide itself to take some action(s) (e.g., decide a new QoS mapping rule) and then inform the network via an (e.g., new) RRC message.

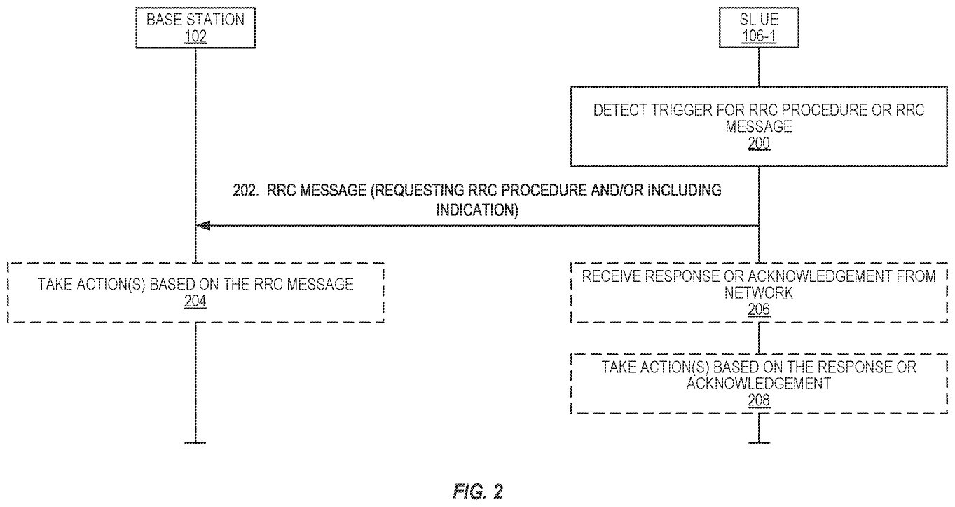

In this regard, FIG. 2 illustrates the operation of the base station 102 and the SL UE 106-1 in accordance with various embodiments of the present disclosure. As illustrated, the SL UE 106-1 detects a trigger (e.g., detects one or more triggering events or conditions) for sending an RRC message to the network for requesting an RRC procedure for SL-related configurations (e.g., SL configuration or SL configuration update) and/or for sending an RRC message to the network with an indication (e.g., information that indicates, to the network, one or more SL-related configurations autonomously made, changed, or updated by the SL UE) (step 200). In some embodiments, the SL UE 106-1 detects a trigger for sending an RRC message to the network for requesting an RRC procedure for SL-related configurations. This detection is the detection that one or more (e.g., predefined or preconfigured) criteria for triggering this RRC procedure request are satisfied. In one embodiment, the one or more (e.g., predefined or preconfigured) criteria for triggering the RRC procedure request for SL-related configurations by the SL UE 106-1 include the need of an SLRB reconfiguration, e.g., due to changed radio conditions or (re)configuration errors. In another embodiment, the one or more (e.g., predefined or preconfigured) criteria for triggering the RRC procedure request for SL-related configurations by the SL UE 106-1 is when there is a new SL QoS flow but there is no clear QoS mapping (i.e., SL QoS flow to SL SLRB), or a new SL QoS mapping is needed from the network (e.g., the current SL SLRB cannot fulfill the SL QoS flow requirement). In another embodiment, the one or more (e.g., predefined or preconfigured) criteria for triggering the RRC procedure request for SL-related configurations by the SL UE 106-1 is when the SL-related UE context has changed at the SL UE 106-1 side (e.g., update of the destination L2 Identity (ID) or new SL unicast link) and this needs to be updated at the network side (e.g., to prevent a wrong SL-related UE context retrieval or sending during handover procedure).

In another embodiment, the trigger for the RRC procedure (e.g., the trigger for an RRC procedure request for SL-related configurations) is the performance, by the SL UE 106-1, of an autonomous action(s) such as, e.g., deciding a new QoS mapping rule or updating the SL-related UE context autonomously. Upon the SL UE 106-1 performing an autonomous action(s) (e.g., deciding a new QoS mapping rule or updating the SL-related UE context autonomously), the SL UE 106-1 detects this trigger for the RRC procedure request for SL-related configurations in order to inform the network of the change(s) that have happened. In another embodiment, the SL UE 106-1 performs autonomous actions when in RRC_IDLE/RRC_INACTIVE states or out of coverage, but triggers the RRC procedure over Uu once the SL UE 106-1 enters the RRC_CONNECTED state for informing the network of the SL-related changes that have happened.

Upon detecting the trigger, the SL UE 106-1 sends the triggered RRC message (e.g., a message requesting an RRC procedure or a message including an indication) to the base station 102 (step 202). As discussed above, the SL UE 106-1 may send the RRC message immediately upon detecting the trigger or at some later time (e.g., after transitioning from RRC_IDLE/RRC_INACTIVE state to RRC_CONNECTED state).

In one embodiment, when the UE is in RRC_CONNECTED state, the RRC message in step 202 is transmitted over the Uu interface for requesting and/or informing the SL-related configurations. In some embodiments, this RRC message sent over the Uu interface is an existing SL-related message such as the SidelinkUElnformation message. In one embodiment, when the UE is in RRC_CONNECTED state, the RRC message used for requesting and/or informing the SL-related configurations is an existing NR (or LTE) message such as the UEAssistancelnformation, ULlnformationTransfer, or ULInformationTransferMRDC (i.e., if DC is enabled) message. In an alternative embodiment, when the SL UE 106-1 is in RRC_CONNECTED state, the RRC message used for requesting and/or informing the SL-related configurations is a new RRC message that is common for any RATs (SL, NR, or LTE). Further, in another embodiment, when the SL UE 106-1 is in RRC_CONNECTED state, the RRC message used for requesting and/or informing the SL-related configurations is a new RRC message that is used only in SL.

In one embodiment, when the SL UE 106-1 is in RRC_IDLE/RRC_INACTIVE state, the RRC message used for requesting and/or informing the SL-related configurations is an existing message such as RRCResumeRequest or the RRCSetupRequest message. In another embodiment, when the SL UE 106-1 is in RRC_IDLE/RRC_INACTIVE state, the RRC message used for requesting and/or informing the SL-related configurations is a new RRC message that is common for any RATs. In another embodiment, when the SL UE 106-1 is in RRC_IDLE/RRC_INACTIVE state, the RRC message used for requesting and/or informing the SL-related configurations is a new RRC message that is used only for SL.

In one embodiment, the content of the RRC message sent by the SL UE 106-1 used for requesting and/or informing the SL-related configurations includes a flag for requesting a new SLRB configuration. In another embodiment, the content of the RRC message sent by the SL UE 106-1 used for requesting and/or informing the SL-related configurations includes new QoS flow(s) information together with an indication of a new QoS mapping needed for the included QoS flow(s). In another embodiment, the content of the RRC message sent by the SL UE 106-1 used for requesting and/or informing the SL-related configurations includes a new SL-related UE context to be stored at the network side (e.g., the gNB, eNB, Next Generation eNB (NG-eNB)).

In one embodiment, the UE sends the RRC message for requesting SL-related configurations to the network via, e.g., SRB1. If DC is enabled, in another embodiment the UE could send such RRC message to the primary network node via, e.g., SRB1. In an alternative embodiment, the UE could send such RRC message to the secondary network node via, e.g., SRB3.

In another embodiment, the SL capable UE receives the response/acknowledgment for such RRC message from the primary node. In one embodiment, the SL capable UE receives the response/acknowledgment for such RRC message from a Secondary Node (SN).

Upon receiving the RRC message, the base station 102 performs one or more actions based on the RRC message (step 204). In one embodiment, upon receiving the RRC message for requesting SL-related configurations from the SL capable UE, the base station 102 sends a response/acknowledgment to the SL UE 106-1. In one embodiment, the response/acknowledgment is an existing RRC message such as (but not limited to) the RRCReconfiguration if the SL UE 106-1 is in RRC_CONNECTED state. Alternatively, in one embodiment, the response/acknowledgment is an existing RRC message such as (but not limited to) the RRCResume, RRCSetup, or Paging message if the SL UE 106-1 is in RRC_IDLE/RRC_INACTIVE.

In one embodiment, if DC is enabled, the base station 102 is the primary network node (e.g., the Master Node (MN)), and, upon receiving the RRC message for requesting SL-related configurations from the SL UE 106-1, the primary network node (e.g., the MN) forwards the RRC message to the secondary node (e.g., the SN) via inter-node control messages. Further, in one embodiment, upon receiving the RRC message for requesting the SL-related configurations forwarded from the primary node (e.g., the MN), the secondary network node (e.g., the SN) generates an RRC message for triggering the requested RRC procedure and forwards the message to the primary node. The primary node then proceeds to forward the message by, e.g., embedding it in a Master Cell Group (MCG) RRC message to the SL UE 106-1 via, e.g., SRB1. In another embodiment, upon receiving the RRC message for requesting the SL-related configurations forwarded from the primary node (e.g., the MN), the secondary network node (e.g., the SN) sends a direct RRC message to trigger the requested RRC procedure to the SL UE 106-1 via, e.g., SRB3.

In another embodiment, if DC is enabled, the base station 102 is the secondary node (e.g., the SN), and, upon receiving the RRC message for requesting the SL-related configurations from the SL UE 106-1, the secondary network node (e.g., the SN) forwards the RRC message to the primary node (e.g., the MN) via inter-node control messages. Further, in one embodiment, upon receiving the RRC message for requesting SL-related configurations forwarded from the secondary node (e.g., the SN), the primary network node (e.g., the MN) generates an RRC message for triggering the requested RRC procedure and forwards it to the SN. Then the SN proceeds to forward the message by, e.g., embedding it in a Secondary Cell Group (SCG) RRC message to the SL UE 106-1 via, e.g., SRB3. In one embodiment, upon receiving the RRC message for requesting SL-related configurations forwarded from the SN, the primary network node sends a direct RRC message to trigger the requested RRC procedure to the SL UE 106-1 via, e.g., SRB1.

In one embodiment, the SL UE 106-1 receives a response or acknowledgment from the network (e.g., either from the base station 102 or from another RAN node (e.g., SN)) (step 206). Upon receiving the response/acknowledgment from the network, the SL UE 106-1 performs one or more actions (step 208). For example, in some embodiments, the response or acknowledgement includes a configuration (e.g., SLRB configuration or QoS mapping rule), and the SL UE 106-1 applies the configuration (e.g., SLRB configuration or QoS mapping rule) received in the response or acknowledgement. As another example, upon receiving the response/acknowledgment from the network (e.g., either from the base station 102 or from another RAN node (e.g., SN)), the SL UE 106-1 goes to RRC_IDLE/RRC_INACTIVE. As yet another example, upon receiving the response/acknowledgment from the network (e.g., either from the base station 102 or from another RAN node (e.g., SN)), the SL UE 106-1 releases the SL communication. In another embodiment, upon receiving the response/acknowledgment from the network (e.g., either from the base station 102 or from another RAN node (e.g., SN)), the SL UE 106-1 performs no action.

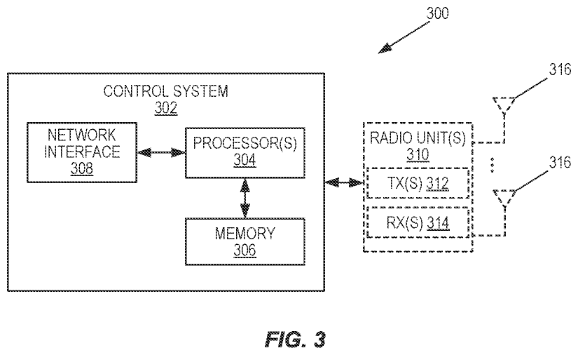

FIG. 3 is a schematic block diagram of a radio access node 300 according to some embodiments of the present disclosure. The radio access node 300 may be, for example, a base station 102 (e.g., a gNB or NG-RAN node). As illustrated, the radio access node 300 includes a control system 302 that includes one or more processors 304 (e.g., Central Processing Units (CPUs), Application Specific Integrated Circuits (ASICs), Field Programmable Gate Arrays (FPGAs), and/or the like), memory 306, and a network interface 308. The one or more processors 304 are also referred to herein as processing circuitry. In addition, the radio access node 300 includes one or more radio units 310 that each includes one or more transmitters 312 and one or more receivers 314 coupled to one or more antennas 316. The radio units 310 may be referred to as or be part of radio interface circuitry. In some embodiments, the radio unit(s) 310 is external to the control system 302 and connected to the control system 302 via, e.g., a wired connection (e.g., an optical cable). However, in some other embodiments, the radio unit(s) 310 and potentially the antenna(s) 316 are integrated together with the control system 302. The one or more processors 304 operate to provide one or more functions of a radio access node 300 as described herein (e.g., one or more functions of the base station 102 as described above, e.g., with respect to FIG. 2). In some embodiments, the function(s) are implemented in software that is stored, e.g., in the memory 306 and executed by the one or more processors 304.

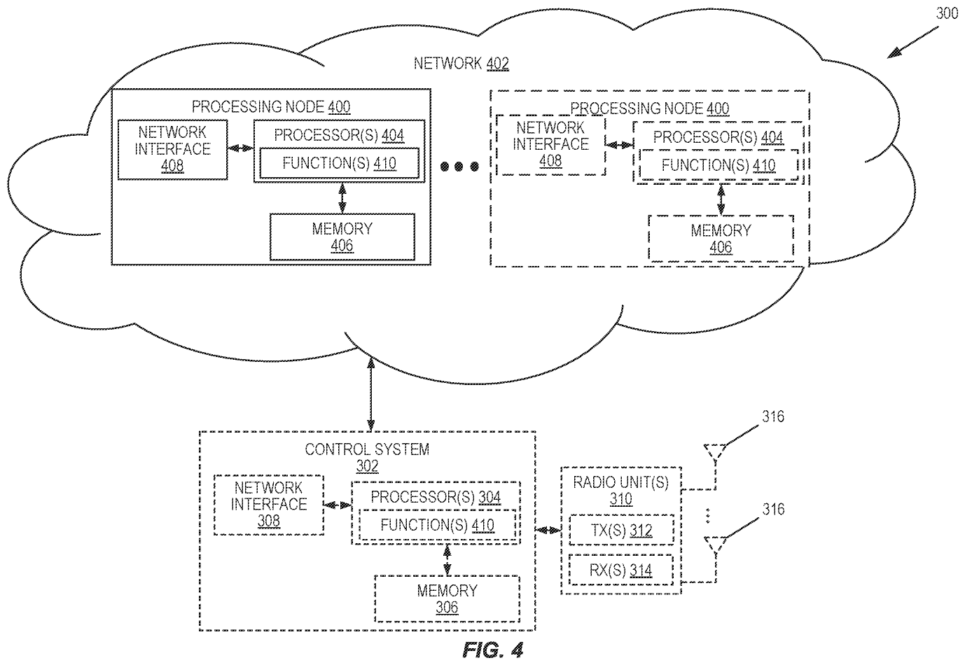

FIG. 4 is a schematic block diagram that illustrates a virtualized embodiment of the radio access node 300 according to some embodiments of the present disclosure. This discussion is equally applicable to other types of network nodes. Further, other types of network nodes may have similar virtualized architectures.

As used herein, a “virtualized” radio access node is an implementation of the radio access node 300 in which at least a portion of the functionality of the radio access node 300 is implemented as a virtual component(s) (e.g., via a virtual machine(s) executing on a physical processing node(s) in a network(s)). As illustrated, in this example, the radio access node 300 includes the control system 302 that includes the one or more processors 304 (e.g., CPUs, ASICs, FPGAs, and/or the like), the memory 306, the network interface 308, and the one or more radio units 310 that each includes the one or more transmitters 312 and the one or more receivers 314 coupled to the one or more antennas 316, as described above. The control system 302 is connected to the radio unit(s) 310 via, for example, an optical cable or the like. The control system 302 is connected to one or more processing nodes 400 coupled to or included as part of a network(s) 402 via the network interface 308. Each processing node 400 includes one or more processors 404 (e.g., CPUs, ASICs, FPGAs, and/or the like), memory 406, and a network interface 408.

In this example, functions 410 of the radio access node 300 described herein (e.g., one or more functions of the base station 102 as described above, e.g., with respect to FIG. 2) are implemented at the one or more processing nodes 400 or distributed across the control system 302 and the one or more processing nodes 400 in any desired manner. In some particular embodiments, some or all of the functions 410 of the radio access node 300 described herein are implemented as virtual components executed by one or more virtual machines implemented in a virtual environment(s) hosted by the processing node(s) 400. As will be appreciated by one of ordinary skill in the art, additional signaling or communication between the processing node(s) 400 and the control system 302 is used in order to carry out at least some of the desired functions 410. Notably, in some embodiments, the control system 302 may not be included, in which case the radio unit(s) 310 communicate directly with the processing node(s) 400 via an appropriate network interface(s).

In some embodiments, a computer program including instructions which, when executed by at least one processor, cause the at least one processor to carry out the functionality of the radio access node 300 or a node (e.g., a processing node 400) implementing one or more of the functions 410 of the radio access node 300 (e.g., one or more functions of the base station 102 as described above, e.g., with respect to FIG. 2) in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

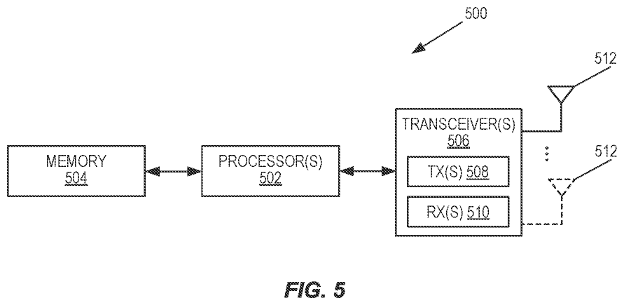

FIG. 5 is a schematic block diagram of a UE 500 according to some embodiments of the present disclosure. As illustrated, the UE 500 includes one or more processors 502 (e.g., CPUs, ASICs, FPGAs, and/or the like), memory 504, and one or more transceivers 506 each including one or more transmitters 508 and one or more receivers 510 coupled to one or more antennas 512. The transceiver(s) 506 includes radio-front end circuitry connected to the antenna(s) 512 that is configured to condition signals communicated between the antenna(s) 512 and the processor(s) 502, as will be appreciated by one of ordinary skill in the art. The processors 502 are also referred to herein as processing circuitry. The transceivers 506 are also referred to herein as radio circuitry. In some embodiments, the functionality of the UE 500 described above (e.g., one or more functions of the SL UE 106-1 as described above, e.g., with respect to FIG. 2) may be fully or partially implemented in software that is, e.g., stored in the memory 504 and executed by the processor(s) 502. Note that the UE 500 may include additional components not illustrated in FIG. 5 such as, e.g., one or more user interface components (e.g., an input/output interface including a display, buttons, a touch screen, a microphone, a speaker(s), and/or the like and/or any other components for allowing input of information into the UE 500 and/or allowing output of information from the UE 500), a power supply (e.g., a battery and associated power circuitry), etc.

In some embodiments, a computer program including instructions which, when executed by at least one processor, causes the at least one processor to carry out the functionality of the UE 500 according to any of the embodiments described herein (e.g., one or more functions of the SL UE 106-1 as described above, e.g., with respect to FIG. 2) is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.). While not being limited thereto, some example embodiments of the present disclosure are provided below.

Embodiment 1: A method implemented in a Sidelink, SL, User Equipment, UE, the method comprising:
detecting a trigger for sending a Radio Resource Control, RRC, message, wherein the RRC message comprises:
   a request for an RRC procedure related to one or more SL-related configurations;
   a message comprising information that informs a network about one or more changes made by the SL UE related to one or more SL configurations; or
   a message that both requests the RRC procedure related to the one or more SL-related configurations and comprises the information that informs the network about the one or more changes made by the SL UE related to the one or more SL configurations; and
sending the RRC message to a network node.

Embodiment 2: The method of embodiment 1, wherein:
the RRC message comprises either:
   the request for the RRC procedure related to the one or more SL-related configurations; or
   the message that both requests the RRC procedure related to the one or more SL-related configurations and comprises the information that informs the network about the one or more changes made by the SL UE related to the one or more SL configurations; and
the RRC procedure comprises either an SL configuration procedure or an SL configuration update procedure.

Embodiment 3: The method of any one of embodiments 1 or 2, wherein detecting the trigger for sending the RRC message comprises detecting one or more criteria, the one or more criteria comprising:
a criterion that an SL Radio Bearer, SLRB, reconfiguration is needed;
a criterion that there is a new SL Quality of Service, QoS, flow but no QoS mapping for the new SL QoS flow;
a criterion that a new SL QoS mapping is needed;
a criterion of a change in an SL-related UE context at the SL UE; or a criterion of performance of one or more autonomous SL-related actions by the SL UE.

Embodiment 4: The method of embodiment 3, wherein the criterion of performance of the one or more autonomous SL-related actions by the SL UE comprises a criterion of autonomously deciding a new SL-related QoS mapping rule or a criterion of autonomously updating an SL-related UE context.

Embodiment 5: The method of any one of embodiments 1 to 4, wherein sending the RRC message to the network node comprises sending the RRC message to the network node upon detecting the trigger.

Embodiment 6: The method of any one of embodiments 1 to 4, wherein:
detecting the trigger for sending the RRC message comprises detecting the trigger for sending the RRC message while the SL UE is in an idle or inactive state; and
sending the RRC message to the network node comprises sending the RRC message to the network node upon detecting the trigger and transitioning from the idle or inactive state to a connected state.

Embodiment 7: The method of any one of embodiments 1 to 6, wherein:
sending the RRC message to the network node comprises sending the RRC message to the network node when in a connected state; and
the RRC message comprises an existing SL-related RRC message.

Embodiment 8: The method of embodiment 7, wherein the existing SL-related RRC message comprises a SidelinkUElnformation message.

Embodiment 9: The method of any one of embodiments 1 to 7, wherein:
sending the RRC message to the network node comprises sending the RRC message to the network node when in a connected state; and
the RRC message comprises an existing New Radio, NR, or Long Term Evolution, LTE, RRC message.

Embodiment 10: The method of embodiment 9, wherein the existing NR or LTE RRC message comprises a UEAssistancelnformation message, a ULlnformationTransfer message, or a ULlnformationTransferMRDC message.

Embodiment 11: The method of any one of embodiments 1 to 7, wherein:
sending the RRC message to the network node comprises sending the RRC message to the network node when in a connected state; and
the RRC message comprises a new RRC message that is common for two or more Radio Access Technologies, RATs.

Embodiment 12: The method of any one of embodiments 1 to 7, wherein:
sending the RRC message to the network node comprises sending the RRC message to the network node when in a connected state; and
the RRC message comprises a new RRC message that is for SL only.

Embodiment 13: The method of any one of embodiments 1 to 5, wherein:
sending the RRC message to the network node comprises sending the RRC message to the network node when in an idle or inactive state; and
the RRC message comprises an existing RRC message.

Embodiment 14: The method of embodiment 13, wherein the existing RRC message comprises a RRCResumeRequest message or a RRCSetupRequest message.

Embodiment 15: The method of any one of embodiments 1 to 5, wherein:
sending the RRC message to the network node comprises sending the RRC message to the network node when in an idle or inactive state; and
the RRC message comprises a new RRC message that is common for two or more Radio Access Technologies, RATs.

Embodiment 16: The method of any one of embodiments 1 to 5, wherein:
sending the RRC message to the network node comprises sending the RRC message to the network node when in an idle or inactive state; and
the RRC message comprises a new RRC message that is used for SL only.

Embodiment 17: The method of any one of embodiments 1 to 16, wherein the RRC message comprises a flag that indicates a request for a new SLRB configuration.

Embodiment 18: The method of any one of embodiments 1 to 17, wherein the RRC message comprises QoS flow information for one or more QoS flows at the SL UE.

Embodiment 19: The method of embodiment 18, wherein the RRC message further comprises an indication of one or more new QoS mappings needed for the one or more QoS flows.

Embodiment 20: The method of any one of embodiments 1 to 16, wherein the RRC message comprises a new SL-related UE context for the SL UE.

Embodiment 21: The method of any one of embodiments 1 to 20, further comprising receiving a response from either the network node or another network node.

Embodiment 22: The method of embodiment 21, wherein the response comprises one or more SL-related configurations or one or more updates to one or more SL-related configurations.

Embodiment 23: The method of any one of embodiments 21 and 22, further comprising taking one or more actions based on the response.

Embodiment 24: The method of any one of embodiments 1 to 23, wherein the network node comprises a base station.

Embodiment 25: The method of any one of embodiments 1 to 24, wherein:
the SL UE uses dual connectivity; and
the network node comprises a Master Node, MN, of the SL UE.

Embodiment 26: The method of any one of embodiments 1 to 24, wherein:
the SL UE uses dual connectivity; and
the network node comprises a Secondary Node, SN, of the SL UE.

Embodiment 27: A Sidelink, SL, User Equipment, UE, adapted to:
detect a trigger for sending a Radio Resource Control, RRC, message, wherein the RRC message comprises:
   a request for an RRC procedure related to one or more SL-related configurations;
   a message comprising information that informs a network about one or more changes made by the SL UE related to one or more SL configurations; or
   a message that both requests the RRC procedure related to the one or more SL-related configurations and comprises the information that informs the network about the one or more changes made by the SL UE related to the one or more SL configurations; and
send the RRC message to a network node.

Embodiment 28: The SL UE of embodiment 27, adapted to perform the method of any one of embodiments 2 to 26.

Embodiment 29: A Sidelink, SL, User Equipment, UE, comprising:
one or more transmitters;
one or more receivers; and
processing circuitry associated with the one or more transmitters and the one or more receivers, the processing circuitry configured to cause the SL UE to:
   detect a trigger for sending a Radio Resource Control, RRC, message, wherein the RRC message comprises:
      a request for an RRC procedure related to one or more SL-related configurations;
      a message comprising information that informs a network about one or more changes made by the SL UE related to one or more SL configurations; or
      a message that both requests the RRC procedure related to the one or more SL-related configurations and comprises the information that informs the network about the one or more changes made by the SL UE related to the one or more SL configurations; and
   send the RRC message to a network node.

Embodiment 30: The SL UE of embodiment 29, wherein the processing circuitry is further configured to cause the SL UE to perform the method of any one of embodiments 2 to 26.

Embodiment 31: A method implemented in a network node, comprising:
receiving a Radio Resource Control, RRC, message from a sidelink, SL, User Equipment, UE, wherein the RRC message is:
   a request for an RRC procedure related to one or more SL-related configurations;
   a message comprising information about one or more changes made by the SL UE related to one or more SL configurations; or
   a message that both requests the RRC procedure related to the one or more SL-related configurations and comprises the information about the one or more changes made by the SL UE related to the one or more SL configurations; and
taking one or more actions based on the RRC message.

Embodiment 32: The method of embodiment 31, wherein the one or more actions comprise sending the RRC message or information in the RRC message to another network node.

Embodiment 33: The method of embodiment 31, wherein: the one or more actions comprise sending a response to the SL UE; and the response comprises the one or more SL-related configurations for the SL UE or one or more updates to the one or more SL-related configurations for the SL UE.

Embodiment 34: The method of any one of embodiments 31 to 33, wherein:
the RRC message comprises either:
   the request for the RRC procedure related to the one or more SL-related configurations; or
   the message that both requests the RRC procedure related to the one or more SL-related configurations and comprises the information about the one or more changes made by the SL UE related to the one or more SL configurations; and
the RRC procedure comprises either an SL configuration procedure or an SL configuration update procedure.

Embodiment 35: The method of any one of embodiments 31 to 34, wherein:
receiving the RRC message from the SL UE comprises receiving the RRC message from the SL UE while the SL UE is in a connected state; and
the RRC message comprises an existing SL-related RRC message.

Embodiment 36: The method of embodiment 35, wherein the existing SL-related RRC message comprises a SidelinkUElnformation message.

Embodiment 37: The method of any one of embodiments 31 to 34, wherein:
receiving the RRC message from the SL UE comprises receiving the RRC message from the SL UE while the SL UE is in a connected state; and
the RRC message comprises an existing New Radio, NR, or Long Term Evolution, LTE, RRC message.

Embodiment 38: The method of embodiment 37, wherein the existing NR or LTE RRC message comprises a UEAssistancelnformation message, a ULInformationTransfer message, or a ULlnformationTransferMRDC message.

Embodiment 39: The method of any one of embodiments 31 to 34, wherein:
receiving the RRC message from the SL UE comprises receiving the RRC message from the SL UE while the SL UE is in a connected state; and
the RRC message comprises a new RRC message that is common for two or more Radio Access Technologies, RATs.

Embodiment 40: The method of any one of embodiments 31 to 34, wherein:
receiving the RRC message from the SL UE comprises receiving the RRC message from the SL UE while the SL UE is in a connected state; and
the RRC message comprises a new RRC message that is for SL only.

Embodiment 41: The method of any one of embodiments 31 to 34, wherein:
receiving the RRC message from the SL UE comprises receiving the RRC message from the SL UE while the SL UE is in an idle or inactive state; and
the RRC message comprises an existing RRC message.

Embodiment 42: The method of embodiment 41, wherein the existing RRC message comprises an RRCResumeRequest message or an RRCSetupRequest message.

Embodiment 43: The method of any one of embodiments 31 to 34, wherein:
receiving the RRC message from the SL UE comprises receiving the RRC message from the SL UE while the SL UE is in an idle or inactive state; and
the RRC message comprises a new RRC message that is common for two or more Radio Access Technologies, RATs.

Embodiment 44: The method of any one of embodiments 31 to 34, wherein:
receiving the RRC message from the SL UE comprises receiving the RRC message from the SL UE while the SL UE is in an idle or inactive state; and
the RRC message comprises a new RRC message that is used for SL only.

Embodiment 45: The method of any one of embodiments 31 to 44, wherein the RRC message comprises a flag that indicates a request for a new SL Radio Bearer, SLRB, configuration.

Embodiment 46: The method of any one of embodiments 31 to 45, wherein the RRC message comprises Quality of Service, QoS, flow information for one or more QoS flows at the SL UE

Embodiment 47: The method of embodiment 46, wherein the RRC message further comprises an indication of one or more new QoS mappings needed for the one or more QoS flows.

Embodiment 48: The method of any one of embodiments 31 to 44, wherein the RRC message comprises a new SL-related UE context for the SL UE.

Embodiment 49: The method of any one of embodiments 31 to 48, wherein the network node comprises a base station.

Embodiment 50: The method of any one of embodiments 31 to 49, wherein:
the SL UE uses dual connectivity; and
the base station comprises a Master Node, MN, of the SL UE.

Embodiment 51: The method of any one of embodiments 31 to 49, wherein:
the SL UE uses dual connectivity; and
the base station comprises a Secondary Node, SN, of the SL UE.

Embodiment 52: A base station adapted to:
receive a Radio Resource Control, RRC, message from a sidelink, SL, User Equipment, UE, wherein the RRC message is:
   a request for an RRC procedure related to one or more SL-related configurations;
   a message comprising information about one or more changes made by the SL UE related to one or more SL configurations; or
   a message that both requests the RRC procedure related to the one or more SL-related configurations and comprises the information about the one or more changes made by the SL UE related to the one or more SL configurations; and
take one or more actions based on the RRC message.

Embodiment 53: The base station of embodiment 52, adapted to perform the method of any one of embodiments 32 to 51.

Embodiment 54: A base station comprising processing circuitry configured to cause the base station to:
receive a Radio Resource Control, RRC, message from a sidelink, SL, User Equipment, UE, wherein the RRC message is:
   a request for an RRC procedure related to one or more SL-related configurations;
   a message comprising information about one or more changes made by the SL UE related to one or more SL configurations; or
   a message that both requests the RRC procedure related to the one or more SL-related configurations and comprises the information about the one or more changes made by the SL UE related to the one or more SL configurations; and
take one or more actions based on the RRC message.

Embodiment 55: The base station of embodiment 54, wherein the processing circuitry is further configured to cause the base station to perform the method of any one of embodiments 32 to 51.

At least some of the following abbreviations may be used in this disclosure:
3GPP Third Generation Partnership Project
5 G Fifth Generation
5 GCN Fifth Generation Core Network
5 GS Fifth Generation System
AMF Access and Mobility Function
AS Access Stratum
AUSF Authentication Server Function
BSR Buffer Status Report
CA Carrier Aggregation
C-ITS Cellular Intelligent Transport Systems
CN Core Network
CP Control Plane
D2D Device-to-Device
DC Dual Connectivity
DCI Downlink Control Information
DRB Data Radio Bearer
DSP Digital Signal Processor
eLTE Enhanced Long Term Evolution
eNB Enhanced or Evolved Node B
EN-DC Evolved Universal Terrestrial Radio Access New Radio Dual Connectivity
EPC Evolved Packet Core
E-UTRA Evolved Universal Terrestrial Radio Access
eV2X Enhanced Vehicle-to-Everything
gNB New Radio Base Station
HSS Home Subscriber Server
ID Identity
ITS Intelligent Transport Systems
LTE Long Term Evolution
MAC Medium Access Control
MC Multi-Connectivity
MCG Master Cell Group
MeNB Master Enhanced or Evolved Node B
MgNB Master New Radio Base Station
MME Mobility Management Entity
MN Master Node
MR-DC Multi-Radio Dual Connectivity
MTC Machine Type Communication
NAS Non-Access Stratum
NE-DC New Radio Evolved Universal Terrestrial Radio Access Dual Connectivity
NEF Network Exposure Function
NF Network Function
NG-eNB Next Generation Enhanced or Evolved Node B
NGEN-DC Next Generation Radio Access Network Evolved Universal
Terrestrial Radio Access New Radio Dual Connectivity
NG-RAN Next Generation Radio Access Network
NR New Radio
NRF Network Function Repository Function
NSSF Network Slice Selection Function
PCF Policy Control Function
PCT Patent Cooperation Treaty
PDCCH Physical Downlink Control Channel
PDCP Packet Data Convergence Protocol
P-GW Packet Data Network Gateway
PSCCH Physical Sidelink Control Channel
PSSCH Physical Sidelink Shared Channel
QoS Quality of Service
RA Resource Allocation
RAM Random Access Memory
RAN Radio Access Network
RAT Radio Access Technology
Rel Release
RLC Radio Link Control
RNA Radio Access Network based Notification Area
ROM Read Only Memory
RRC Radio Resource Control
RX Reception
SA Stand-Alone
SCEF Service Capability Exposure Function
SCG Secondary Cell Group
SCI Sidelink Control Information
SDAP Service Data Adaptation Protocol
SeNB Secondary Enhanced or Evolved Node B
SgNB Secondary New Radio Base Station
SIB System Information Block
SL Sidelink
SLRB Sidelink Radio Bearer
SMF Session Management Function
SN Secondary Node
SRB Signaling Radio Bearer
TR Technical Report
TS Technical Specification
TX Transmission
UDM Unified Data Management
UE User Equipment
UP User Plane
UPF User Plane Function
URLLC Ultra Reliable Low Latency Communications
V2I Vehicle-to-Infrastructure
V2 P Vehicle-to-Pedestrian
V2V Vehicle-to-Vehicle
V2X Vehicle-to-Everything

1. A method implemented in a Sidelink, SL, User Equipment, UE, the method comprising:
detecting a trigger for sending a Radio Resource Control, RRC, information, wherein the RRC information comprises:
a request for an RRC procedure related to one or more SL-related configurations;
a message comprising information that informs a network about one or more changes made by the SL UE related to one or more SL configurations; or
a message that both requests the RRC procedure related to the one or more SL-related configurations and comprises the information that informs the network about the one or more changes made by the SL UE related to the one or more SL configurations; and
sending the RRC information to a network node.

2. The method of claim 1, wherein:
the RRC information comprises either:
the request for the RRC procedure related to the one or more SL-related configurations; or
the message that both requests the RRC procedure related to the one or more SL-related configurations and comprises the information that informs the network about the one or more changes made by the SL UE related to the one or more SL configurations; and
the RRC procedure comprises either an SL configuration procedure or an SL configuration update procedure.

3. The method of claim 1, wherein detecting the trigger for sending the RRC information comprises detecting one or more criteria, the one or more criteria comprising:
a criterion that an SL Radio Bearer, SLRB, reconfiguration is needed;
a criterion that there is a new SL Quality of Service, QoS, flow but no QoS mapping for the new SL QoS flow;
a criterion that a new SL QoS mapping is needed;
a criterion of a change in an SL-related UE context at the SL UE; or
a criterion of performance of one or more autonomous SL-related actions by the SL UE said criterion comprising a criterion of autonomously deciding a new SL-related QoS mapping rule or a criterion of autonomously updating an SL-related UE context.

4. (canceled)

5. (canceled)

6. The method of claim 1, wherein:
detecting the trigger for sending the RRC information comprises detecting the trigger for sending the RRC information while the SL UE is in an idle or inactive state; and
sending the RRC information to the network node comprises sending the RRC information to the network node upon detecting the trigger and transitioning from the idle or inactive state to a connected state.

7. The method of claim 1, wherein:
sending the RRC information to the network node comprises sending the RRC information to the network node when in a connected state; and
the RRC information comprises an existing SL-related RRC information, wherein the existing SL-related RRC information comprises a SidelinkUElnformation message.

8. (canceled)

9. The method of claim 1, wherein:
sending the RRC information to the network node comprises sending the RRC information to the network node when in a connected state; and
the RRC information comprises an existing New Radio, NR, or Long Term Evolution, LTE, RRC information, wherein the existing NR or LTE RRC information comprises a UEAssistancelnformation message, a ULlnformationTransfer message, or a ULlnformationTransferMRDC message.

10-12. (canceled)

13. The method of claim 1, wherein:
sending the RRC information to the network node comprises sending the RRC information to the network node when in an idle or inactive state; and
the RRC information comprises existing RRC information, wherein the existing RRC information comprises a RRCResumeRequest message or a RRCSetupRequest message.

14. (canceled)

15. The method of claim 1, wherein:
sending the RRC information to the network node comprises sending the RRC information to the network node when in an idle or inactive state; and
the RRC information comprises a new RRC message that is common for two or more Radio Access Technologies, RATs.

16. The method of claim 1, wherein:
sending the RRC information to the network node comprises sending the RRC information to the network node when in an idle or inactive state; and
the RRC information comprises a new RRC message that is used for SL only.

17. The method of claim 1, wherein the RRC information comprises a flag that indicates a request for a new SLRB configuration.

18. The method of claim 1, wherein the RRC information comprises QoS flow information for one or more QoS flows at the SL UE.

19. The method of claim 18, wherein the RRC information further comprises an indication of one or more new QoS mappings needed for the one or more QoS flows.

20. The method of claim 1, wherein the RRC information comprises a new SL-related UE context for the SL UE.

21-28. (canceled)

29. A Sidelink, SL, User Equipment, UE, comprising:
one or more transmitters;
one or more receivers; and
processing circuitry associated with the one or more transmitters and the one or more receivers, the processing circuitry configured to cause the SL UE to:
detect a trigger for sending a Radio Resource Control, RRC, message, wherein the RRC information comprises:
a request for an RRC procedure related to one or more SL-related configurations;
a message comprising information that informs a network about one or more changes made by the SL UE related to one or more SL configurations; or
a message that both requests the RRC procedure related to the one or more SL-related configurations and comprises the information that informs the network about the one or more changes made by the SL UE related to the one or more SL configurations; and
send the RRC information to a network node.

30. (canceled)

31. A method implemented in a network node, comprising:
receiving a Radio Resource Control, RRC, message from a sidelink, SL, User Equipment, UE, wherein the RRC information is:
a request for an RRC procedure related to one or more SL-related configurations;
a message comprising information about one or more changes made by the SL UE related to one or more SL configurations; or
a message that both requests the RRC procedure related to the one or more SL-related configurations and comprises the information about the one or more changes made by the SL UE related to the one or more SL configurations; and
taking one or more actions based on the RRC information.

32. (canceled)

33. The method of claim 31, wherein:
the one or more actions comprise sending a response to the SL UE; and
the response comprises the one or more SL-related configurations for the SL UE or one or more updates to the one or more SL-related configurations for the SL UE.

34. The method of claim 31, wherein:
the RRC information comprises either:
the request for the RRC procedure related to the one or more SL-related configurations; or
the message that both requests the RRC procedure related to the one or more SL-related configurations and comprises the information about the one or more changes made by the SL UE related to the one or more SL configurations; and
the RRC procedure comprises either an SL configuration procedure or an SL configuration update procedure.

35. The method of claim 31, wherein:
receiving the RRC information from the SL UE comprises receiving the RRC information from the SL UE while the SL UE is in a connected state; and
the RRC information comprises existing SL-related RRC information.

36. The method of claim 35, wherein the existing SL-related RRC information comprises a SidelinkUElnformation message.

37. The method of claim 31, wherein:
receiving the RRC information from the SL UE comprises receiving the RRC information from the SL UE while the SL UE is in a connected state; and
the RRC information comprises an existing New Radio, NR, or Long Term Evolution, LTE, RRC information.

38. The method of claim 37, wherein the existing NR or LTE RRC information comprises a UEAssistancelnformation message, a ULlnformationTransfer message, or a ULlnformationTransferMRDC message.

39. The method of claim 31, wherein:
receiving the RRC information from the SL UE comprises receiving the RRC information from the SL UE while the SL UE is in a connected state; and
the RRC information comprises new RRC information that is one of: common for two or more Radio Access Technologies, RATs, and for SL only.

40-51. (canceled)

52. A base station adapted to:
receive a Radio Resource Control, RRC, information from a sidelink, SL, User Equipment, UE, wherein the RRC information is:
a request for an RRC procedure related to one or more SL-related configurations;
a message comprising information about one or more changes made by the SL UE related to one or more SL configurations; or
a message that both requests the RRC procedure related to the one or more SL-related configurations and comprises the information about the one or more changes made by the SL UE related to the one or more SL configurations; and
take one or more actions based on the RRC information.

53. (canceled)

54. A base station comprising processing circuitry configured to cause the base station to:
receive a Radio Resource Control, RRC, message from a sidelink, SL, User Equipment, UE, wherein the RRC information is:
a request for an RRC procedure related to one or more SL-related configurations;
a message comprising information about one or more changes made by the SL UE related to one or more SL configurations; or
a message that both requests the RRC procedure related to the one or more SL-related configurations and comprises the information about the one or more changes made by the SL UE related to the one or more SL configurations; and
take one or more actions based on the RRC information.

55. (canceled)
